(19) United States
(12) Patent Application Publication
(10) Pub. No.: US 2024/0205101 A1
(43) Pub. Date: Jun. 20, 2024

(54) INTER-NODE EXCHANGE OF DATA FORMATTING CONFIGURATION

(71) Applicant: Telefonaktiebolaget LM Ericsson (publ), Stockholm (SE)

(72) Inventors: Pablo Soldati, Solna (SE); Euhanna Ghadimi, Bromma (SE)

(21) Appl. No.: 18/288,846

(22) PCT Filed: May 6, 2022
(86) PCT No.: PCT/EP2022/062358

§ 371 Date: Oct. 30, 2023

Related U.S. Application Data
(60) Provisional application No. 63/185,126, filed on May 6, 2021.

(51) Int. Cl. H04L 41/16; H04W 24/02

(52) U.S. Cl. CPC H04L 41/16; H04W 24/02

(57) ABSTRACT

Systems and methods are disclosed for inter-node exchange of data formatting configuration related to formatting of data for execution of a at least a machine learning (ML) or artificial intelligence (AI) process, or ML or AI model thereof. In one embodiment, a method performed by a first network node comprises receiving a first message from a second network node, the first message comprising information about how to format data for execution of at least a ML or AI process, or ML or AI model thereof, that is available for execution at the first network node. The method further comprises executing the at least a ML or AI process, or the ML or AI model thereof, based on the information comprised in the first message.

### RELATED APPLICATIONS

This application claims the benefit of provisional patent application Ser. No. 63/185,126, filed May 6, 2021, the disclosure of which is hereby incorporated herein by reference in its entirety.

### TECHNICAL FIELD

The present disclosure relates to a wireless communication system such as a Third Generation Partnership Project (3GPP) system and, more specifically, to the use of Machine Learning (ML) or Artificial Intelligence (AI) in a wireless communication system.

### BACKGROUND

### 1 3GPP E-UTRAN Architecture

As illustrated in FIG. 1, the Third Generation Partnership Project (3GPP) Long Term Evolution (LTE) Evolved Universal Terrestrial Radio Access Network (E-UTRAN) architecture consists of evolved Node Bs (eNBs), Mobility Management Entities (MMEs), and System Architecture Evolution Gateways (S-GWs). An S1 interface connects the eNBs to the MME/S-GW, while connectivity between eNBs is supported by an X2 interface.

### 2 3GPP NG-RAN Architecture

The current 3GPP Fifth Generation (5G) Radio Access Network (RAN), or Next Generation RAN (NG-RAN), architecture is depicted in FIG. 2 and described in 3GPP Technical Specification (TS) 38.401 v16.5.0. The NG-RAN consists of a set of New Radio (NR) base stations (gNBs) connected to the 5G Core (5GC) through the NG interface. A gNB can support Frequency Division Duplexing (FDD) mode, Time Division Duplexing (TDD) mode, or dual mode operation. gNBs can be interconnected through the Xn interface. A gNB may consist of a gNB Central Unit (gNB-CU) and one or more gNB Distributed Units (gNB-DUs). A gNB-CU and a gNB-DU are connected via the F1 logical interface. One gNB-DU might be connected to only one gNB-CU. For resiliency, a gNB-DU may be connected to multiple gNB-CUs by appropriate implementation. NG, Xn, and F1 are logical interfaces. The NG-RAN is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1), the related TNL protocol and the functionality are specified. The TNL provides services for user plane transport and signaling transport.

A gNB may also be connected to an LTE eNB via the X2 interface. Another architectural option is where an LTE eNB that is connected to the Evolved Packet Core (EPC) network is also connected over the X2 interface with a so called nr-gNB. The latter is a gNB not connected directly to a core network and connected via X2 to an eNB for the sole purpose of performing dual connectivity.

The architecture in FIG. 2 can be expanded by spitting the gNB-CU into two entities, namely, a User Plane (UP) entity (i.e., a gNB-CU-UP) and a Control Plane (CP) entity (i.e., a gNB-CU-CP). The gNB-CU-UP serves the user plane and hosts the Packet Data Convergence Protocol (PDCP) layer, and the gNB-CU-CP serves the control plane and hosts the PDCP and Radio Resource Control (RRC) layer. For completeness, it should be said that a gNB-DU hosts the Radio Link Control (RLC), Medium Access Control (MAC), and Physical (PHY) layers.

### 3 ML/AI in RAN Systems

Recently Artificial Intelligence (AI) and Machine Learning (ML) have been advocated to enhance performance of radio access networks, such as the 3GPP LTE Advanced (LTE-A) system and the 3GPP NG-RAN system.

### 3.1 Short Introduction to ML/AI

ML/AI algorithms differ from the traditional rule-based algorithm in the way their logic is constructed. In traditional algorithms, the logic is generated based on a fixed system-modeling designed by domain experts that is believed to hold while running the algorithm. Examples include designing a power control algorithm for a cell by assuming a certain distribution to model the signal propagation in the communication environment (such as Rayleigh or log-normal). As long as underlying assumptions hold, the outcome of the power control algorithm would match exactly to the model in which the algorithm is built upon. As a result, if underlying assumptions change or do not hold anymore, a complete algorithm redesign is necessary as the running algorithm cannot adapt to the new conditions and, hence, its performance decreases.

A ML/AL based algorithm, however, is built to be data driven. That is, the logic of a ML/AI algorithm is directly extracted from the input data, In the example of power control, the current condition of the communication network (e.g., the propagation conditions, the received signal quality, and the interference situation) is represented by a set of input parameters (features), and the ML/AI algorithm selects the power of the cell according to the input information provided to it. Finding the logic of the ML/AI algorithm is done by optimizing the algorithm output for a wide set of input data (so called training data) collected from different conditions of the network. Such procedure is referred as training, and the output of the training process is the ML/AI algorithm for the power control. Since the ML/AL algorithm is trained under different network conditions possibly rich enough to span over a variety of conditions that might happen in the real network, it has the potential to outperform rule-based algorithms that are designed under certain assumption which might not always hold in the real network. Finally, since the logic of ML/AI algorithm is directly extracted from the input data, it then can be updated (re-trained) using a new set of training data in cases that current trained ML/AI algorithm no longer matches the current conditions of the network (e.g., if some network Key Performance Indicators (KPIs) drop).

### 3.2 ML/AI in O-RAN

The Open RAN (O-RAN) Alliance is considering ML/AI to drive performance enhancements for several aspects of the RAN operation. In O-RAN Working Group 2, “AI/ML workflow description and requirements”, February 2021, the O-RAN Working Group 2 has provided an updated overview of the AI/ML workflow description and requirements for supporting ML/AI-driven operations in RANs. FIG. 3 shows the ML components and terminologies as described in the “AI/ML workflow description and requirements” document.

A description of the functional blocks of this ML framework envisioned by O-RAN is provided in the following table:

| Definitions | Note/example |
|---|---|
| Application: An application is a complete and | Generally, an AI/ML application should contain a |
| deployable package, environment to achieve a | logically top-level AI/ML model and application-level |
| certain function in an operational environment. An | descriptions |
| AI/ML application is one that contains some AI/ML | |
| models. | |
| ML-assisted Solution: A solution which addresses | As an example, video optimization using ML is an |
| a specific use case using Machine-Learning | ML-assisted solution. |
| algorithms during operation. | |
| ML Model: The ML methods and concepts used | ML models include supervised learning, |
| by the MLassisted solution. Depending on the | unsupervised learning, reinforcement learning, |
| implementation a specific ML model could have | deep neural network, and depending on use-case, |
| many sub-models as components and the ML | appropriate ML model has to be chosen. Separately |
| model should train all sub-models together. | trained ML models can also be chained together in |
| | a ML pipeline during inference. |
| ML Workflow: A ML workflow is the process | Based on ML model chosen, some or all of the |
| consisting of data collection and preparation, | phases of workflow will be included. |
| model building, model training, model deployment, | |
| model execution, model validation, continuous | |
| model self-monitoring and self-learning/retraining | |
| related to ML-assisted solutions | |
| ML (model) Life-cycle: The life-cycle of the ML | These are operational phases: the initial training, |
| model includes deployment, instantiation and | inference, possible re-training |
| termination of ML model components. | |
| ML Pipeline: The set of functionalities, functions, | A ML pipeline may consist of one or several data |
| or functional entities specific for an ML-assisted | sources in a data pipeline, a model training |
| solution. | pipeline, a model evaluation pipeline and an actor. |
| ML Training Host: The network function which | Non-RT RIC can also be a training host. ML training |
| hosts the training of the model, including offline | can be performed offline using data collected from |
| and online training | the RIC, O-DU and O-RU. |
| ML Inference Host: The network function which | The ML inference host often coincides with the |
| hosts the ML model during inference mode (which | Actor. The ML-host informs the actor about the |
| includes both the model execution as well as any | output of the ML algorithm, and the Actor takes a |
| online learning if applicable). | decision for an action. |
| Actor: The entity which hosts an ML assisted | |
| solution using the output of ML model inference. | |
| Action: An action performed by an actor as a | |
| result of the output of an ML assisted solution. | |
| Subject of Action: The entity or function which is | |
| configured, controlled, or informed as result of the | |
| action. | |
| Model training information: Information needed for | This is the data of the ML model including the input |
| training the ML model. | plus optional labels for supervised training |
| Model inference information: Information needed | The data needed by an ML model for training and |
| as input for the ML model for inference | inference may largely overlap, however they are |
| | logically different. |
| Model compiling info: Information needed for | It includes the trained ML model , model inference |
| compiling the ML model. | host info, and other possible requirements for |
| | model compiling, e.g., acceptable accuracy loss |
| | thresholds, any specific operations to be performed. |
| Model inference host info: Information of the | This may include information e.g., network |
| inference host needed as model compiling info. | bandwidth, memory and computing capabilities of |
| | the inference host. |
| Model Compiling Host: Optional network function | Model compiling involves hardware specific |
| which compiles the trained model into specific | optimization to achieve improved computing and |
| format for optimized inference execution in an | memory efficiency. According to different |
| inference host based on the compiling information. | deployment methods, the compiled model could be |
| | published to the model store/management module |
| | as a containerized image (including Inference |
| | Engine and compiled models) or a compiled model |
| | file format, and then deployed to the inference host. |
| | Non-RT RIC can also be a compiling host. ML |
| | compiling can be performed offline |
| Model Inference Engine: The specific inference | The functions of model inference engine includes |
| framework used to run a compiled model in the | parsing model files, splitting operations, and |
| inference host. | executing inference instruction stream to finish ML |
| | model inference calculation and return inference |
| | result. |
| Model Management: The network function that | Model management manages models that are |
| manages the ML models to be deployed in the | onboarded directly from ML training host or those |
| inference host. | from ML compiling host when model compiling is |
| | executed after training. |
| Data Discovery: Data discovery uses smart tools | The general process includes data collecting, data |
| to collect data from multiple sources and then | cleansing, data loading, data transforming, data |
| consolidate them to a single source for easy use. | mining and data visualization |
| Data Augmentation: Data augmentation could be | There are two types of data: Time series data: |
| used to enhance the model generalization and | augmentation with consideration of event |
| reduce overfitting, especially when dataset is | distribution pattern in temporal space Non-time |
| limited or imbalance exists. | series data: augmentation with physical constraint |
| Data Labelling: Data labelling is a time-consuming | The labelled data should be validated crossly, and |
| task and needs domain knowledge. The platform | some label mistakes should be eliminated |
| should provide or integrate various labelling/ auto- | |
| labelling tools for offline/online annotation. | |
| Feature Engineering: At the beginning of model | Design the feature extraction mechanism, such as |
| design, we need to study and define what kinds of | learning from multiple modalities, or learning from |
| features could be learnt to represent the | single modality, etc. Meanwhile, we need to define |
| objectives or data, and what kinds of actions | which features could be leveraged and which could |
| should be used to for better prediction | be fused with other features. Nowadays, end2end |
| performance. | system building is emerging also, but raw data is |
| | also a kind of feature in this context. This is an |
| | optional operation for model training. |
| Model Selection: When initiating a training task, | For model design, the following factors should be |
| ML designer will assess the cost and resources | considered: |
| for training or inference, such as hardware | ML meta architecture for specific tasks |
| platform to inference, GPU memory, inference | ML/DL framework (pytorch, tensorflow, caffe, |
| speed, training accuracy, training time, etc. Based | etc.) |
| on those requirements analysis, the system can | Data format of input and output |
| select the corresponding configurations for | Requirements on model performance |
| training or inference. | (accuracy, responding time, real-time factor, |
| | etc.) |
| | Model footprint and HW platform (ARM, GPU, |
| | CPU, FPGA, etc.) |
| | Task requirements |
| Model Optimization: Model optimization refers to | For example, using auto machine learning |
| the efforts to optimize model performance. | (AutoML) to optimize the hyperparameters or deep |
| Optimizing models based on certain hardware or | learning neural networks (DNN, CNN, RNN, etc.) |
| performance metrics requirements | structure. |
| | Optimization Metrics: |
| | Model size |
| | Memory used |
| | Inference speed |
| | Accuracy (precision/recall, etc.) |
| | Hardware platform processing capability, etc. |
| | According to the hardware platform running models, |
| | model compression could also be involved as one |
| | of optimization technique. |
| Model Compression: With specific real-time | At this stage, the system will check the model |
| requirement and hardware constraints, inference | requirements and running hardware platform to |
| engine running on edge device for example, | decide which compression strategy that could be |
| model compression will be critical and a must to | adopted. The training process will be integrated |
| further reduce the model footprint and therefore to | with compression to generate the satisfied models |
| speed up the inference engine. | |
| Model Training: Model training should consider | Meanwhile, the training process should be |
| the training platform capability, available | monitored to see whether the process is converged |
| resources and energy consumption for training | or collect key information, such as memory used, |
| | loss, accuracy, etc. |
| Model Testing: Model testing refers to validate | It could include the validation process and real |
| model performance with testing data | testing in product environment. With model testing, |
| | we can understand the trained model capability in |
| | product environment, and also possible defects. |
| Model Deployment: Model deployment should fully | Data input/output should also be considered to |
| consider the inference hardware capability and | reduce I/O delay. |
| stability. | |
| Inference Monitoring: Monitoring inference | |
| process and collect ML system/model key | |
| messages. | |
| Model Refine: After deploying a model for certain | |
| time, the model should be refined based on the | |
| test results or feedback from the test loop due to | |
| the shifting of data distribution, changing of | |
| environment, accumulated errors, etc. | |
| Continuous Operations: Provides a series of | |
| online functionalities for the continuous | |
| improvement of AI/ML models within the whole | |
| AI/ML lifecycle. It includes Verification/Monitoring/ | |
| Analysis/Recommendation/Continue | |
| Optimization. | |
| Verification: Verified the model performance | |
| online in the real deployed environment | |
| Analysis: Includes data analysis, data/label | |
| conflict analysis, performance prediction, business | |
| insight etc. | |
| Recommendation: Co-work with analysis to | |
| provide continuous improvements | |
| recommendations. | |
| Continuous Optimization: Provides AI pipeline | |
| optimization, Decision optimization etc. during | |
| AI/ML LCM. | |

### 3.3 ML/AI in 3GPP

A similar functional framework, depicted in FIG. 4, is currently being discussed in 3GPP to support AI/ML driven RAN functionalities in the 3GPP NG-RAN system (see 3GPP Technical Report (TR) 37.817 “Study on enhancement for Data Collection for NR and EN-DC (rel-17)”, v0.1.0, 2021-01). In this case, while the framework is still not finalized by 3GPP, one possible description of the functional blocks depicted in FIG. 4 is as follows:
Data Collection & Preparation: A function which collects data, performs data pre-processing, and provides the training and inference data to model training and model inference function
Model Training: A function which performs ML online/offline training, generates an ML model, and sends the ML model to ML inference function
Model Inference: A function which performs ML inference, generates the inference results, and sends the results to action function. The model performance feedback can be provided by ML inference to ML training to trigger the ML model re-training.
Action: A function which generates the network optimization policy based on ML inference results and executes the policy, or executes the policy directly generated from ML inference function. The function could be further decomposed of actor and subject of action if needed.
Actor: A function which hosts the ML-assisted solution by using the ML inference results.
Subject of action: A function which is configured, controlled, or informed as result of the ML-assisted solution.
Model performance feedback: The evaluation of model effectiveness.
Performance feedback: The evaluation of actual network performance after applying ML-assisted solution.

### Summary

Systems and methods are disclosed for inter-node exchange of data formatting configuration related to formatting of data for execution of a at least a machine learning (ML) or artificial intelligence (AI) process, or ML or AI model thereof. In one embodiment, a method performed by a first network node comprises receiving a first message from a second network node, the first message comprising information about how to format data for execution of at least a ML or AI process, or ML or AI model thereof, that is available for execution at the first network node. The method further comprises executing the at least a ML or AI process, or the ML or AI model thereof, based on the information comprised in the first message. In this manner, the first network node is enabled to properly execute the ML or AI process, or the ML or AI model thereof, when the ML or AI process, or the ML or AI model thereof, has been trained by the second network node

In one embodiment, the ML or AI process, or the ML or AI model thereof, is trained at the second network node and provided to the first network node.

In one embodiment, executing the at least a ML or AI process, or the ML or AI model thereof, based on the information comprised in the first message comprises formatting at least one input data provided to the ML or AL process, or the ML or AI model thereof, and/or at least one output data provided by the ML or AL process, or the ML or AI model thereof, based on the information comprised in the first message.

In one embodiment, executing the at least a ML or AI process, or the ML or AI model thereof, based on the information comprised in the first message comprises: (a) formatting information used as input to the ML or AI process, or the ML or AI model thereof, based on scaling information comprised in the information comprised the first message; (b) obtaining an output from the ML or AI process, or the ML or AI model thereof, by executing the ML or AI process, or the ML or AI model thereof, using input data formatted according to the information comprised in the first message; (c) formatting an output provided by the ML or AI process, or the ML or AI model thereof, based on de-scaling information comprised in the formatting information comprised in the first message; (d) applying an output provided by the ML or AI process, or the ML or AI model thereof, that is formatted according to the information comprised in the first message to an associated network function or communication device; or (e) a combination of any two or more of (a)-(d).

In one embodiment, the ML or AI process, or the ML or AI model thereof, is trained to optimize one or more operations or functions of the first network node or to optimize one or more operations or configurations associated to a communication device connected to the first network node.

In one embodiment, the information comprised in the first message comprises: (a) an indication of at least a data scaling and/or descaling criterion to be applied for at least one input data of the ML or AI process, or the ML or AI model thereof; (b) an indication of at least a data format to be applied for at least one input data of the ML or AI process, or the ML or AI model thereof; (c) an indication of at least a data scaling and/or de-scaling criterion to be applied for at least one output data of the ML or AI process, or the ML or AI model thereof; (d) an indication of at least a data format to be used for at least one output data of the ML or AI process, or the ML or AI model thereof; (e) an indication of at least a normalization criterion to be applied for at least one input data of the ML or AI process, or the ML or AI model thereof; (f) an indication of at least a normalization criterion to be applied for at least one output data of the ML or AI process, or the ML or AI model thereof; (g) an indication of at least one parameter to be utilized in a normalization function to be applied for at least one input data and/or to an output data of the ML or AI process, or the ML or AI model thereof; or (h) a combination of any two or more of (a)-(g).

In one embodiment, the information comprised in the first message comprises information that indicates a linear or non-linear scaling function to be utilized by the first network node to scale at least one input data to the ML or AI process, or the ML or AI model thereof, and/or to descale at least one output data of the ML or AI process, or the ML or AI model thereof.

In one embodiment, the information comprised in the first message comprises: (a) an indication of at least a maximum value or an upper bound value associated to at least one input data used for the ML or AI process, or the ML or AI model thereof; (b) an indication of at least a minimum value or a lower bound value associated to at least one input data used for the ML or AI process, or the ML or AI model thereof; (c) an indication of at least one statistical momentum associated to at least one input data used for the ML or AI process, or the ML or AI model thereof; (d) an indication of at least a maximum value or an upper bound value associated to at least one output element of the ML or AI process, or the ML or AI model thereof; (e) an indication of at least a minimum value or a lower bound value associated to at least one output element of the ML or AI process, or the ML or AI model thereof; (f) an indication of at least one statistical momentum associated to at least one output element of the ML or AI process, or the ML or AI model thereof; (g) an indication of at least one bias and/or scaling parameter to transform a distribution of at least one input or output element of the ML or AI process, or the ML or AI model thereof; or (h) a combination of any two or more of (a)-(g).

In one embodiment, the information comprised in the first message comprises information that indicates: (a) an extended validity period associated to information about how to format data for execution of at least a ML or AI process, or ML or AI model thereof, available at the first network node; (b) a level of accuracy associated to information about how to format data for execution of at least a ML or AI process, or ML or AI model thereof, available at the first network node; (c) an indication of an expected performance degradation associated to information about how to format data for execution of at least a ML or AI process, or ML or AI model thereof, available at the first network node; or (d) a combination of any two or more of (a)-(c).

In one embodiment, the method further comprises prior to receiving the first message, transmitting a second message to the second network node, the second message comprising a request for information about how to format data for execution of the at least the ML or AI process, or the ML or AI model thereof. In one embodiment, the second message comprises: (a) a request for at least a data scaling and/or descaling criterion to be applied for at least one input data of the ML or AI process, or the ML or AI model thereof; (b) a request for at least a data format to be applied for at least one input data of the ML or AI process, or the ML or AI model thereof; (c) a request for at least a data scaling and/or de-scaling criterion to be applied for at least one output data of the ML or AI process, or the ML or AI model thereof; (d) a request for at least a data format to be used for at least one output data of the ML or AI process, or the ML or AI model thereof; (e) a request for at least a normalization criterion to be applied for at least one input data of the ML or AI process, or the ML or AI model thereof; (f) a request for at least a normalization criterion to be applied for at least one output data of the ML or AI process, or the ML or AI model thereof; (g) a request for at least one parameter to be utilized in the normalization function to be applied for at least one input data and/or to an output data of the ML or AI process, or the ML or AI model thereof; or (h) a combination of any two or more of (a)-(h).

In one embodiment, the second message comprises: (a) a request for at least a maximum value or an upper bound value associated to at least one input data used for the ML or AI process, or the ML or AI model thereof; (b) a request for at least a minimum value or a lower bound value associated to at least one input data used for the ML or AI process, or the ML or AI model thereof; (c) a request for at least one statistical momentum associated to at least one input data used for the ML or AI process, or the ML or AI model thereof; (d) a request for at least a maximum value or an upper bound value associated to at least one output element of the ML or AI process, or the ML or AI model thereof; (e) a request for at least a minimum value or a lower bound value associated to at least one output element of the ML or AI process, or the ML or AI model thereof; (f) a request for at least one statistical momentum associated to at least one output element of the ML or AI process, or the ML or AI model thereof; (g) a request for at least one bias and/or scaling parameter to transform a distribution of at least one input or output element of the ML or AI process, or the ML or AI model thereof; or (h) a combination of any two or more of (a)-(g).

In one embodiment, the second message comprises: (a) a list of instructions to start, stop, pause, resume, or modify the reporting of assistance information associated to formatting data for at least the ML or AI process, or the ML or AI model thereof, available at the first network node; (b) a list of at least one ML/AI process, and/or ML/AI models thereof, for which reporting of data formatting from the second network node is requested; (c) a reporting periodicity; (d) a request for one-time reporting; (e) a reporting criteria; or (f) a combination of any two or more of (a)-(e).

In one embodiment, the method further comprises receiving a fourth message from the second network node, the fourth message comprising a request or configuration for the first network node to provide at least one data sample generated by the first network node upon executing the ML or AL process, or the ML or AL model thereof.

In one embodiment, the method further comprises transmitting a fifth message to the second network node, the fifth message comprising at least one data sample generated by the first network node upon executing the ML or AL process, or the ML or AL model thereof.

In one embodiment, the at least one data sample comprises: (a) a data sample associated to the execution of the ML or AL process, or the ML or AL model thereof, prior to using the information about how the data is to be formatted comprised in the first message, (b) a data sample associated to the execution of the ML or AL process, or the ML or AL model thereof, when using the information about how the data is to be formatted comprised in the first message, or (c) both (a) and (b).

In one embodiment, the at least one data sample comprises: (a) at least one input data to the ML or AL process, or the ML or AL model thereof, (b) at least one output data provided by the ML or AL process, or the ML or AL model thereof, or (c) both (a) and (b).

Corresponding embodiments of a first network node are also disclosed, In one embodiment, the first network node comprises processing circuitry configured to cause the first network node to receive a first message from a second network node, the first message comprising information about how to format data for execution of at least a ML or AI process, or ML or AI model thereof, that is available for execution at the first network node. The processing circuitry is further configured to cause the first network node to execute the at least a ML or AI process, or the ML or AI model thereof, based on the information comprised in the first message.

Embodiments of a method performed by a second network node are also disclosed. In one embodiment, a method performed by a second network node comprises transmitting a first message to a first network node, the first message comprising information about how to format data for execution of at least a ML or AI process, or ML or AI model thereof, that is available for execution at the first network node.

Corresponding embodiments of a second node are also disclosed. In one embodiment, a second network node comprises processing circuitry configured to cause the second network node to transmit a first message to a first network node, the first message comprising information about how to format data for execution of at least a ML or AI process, or ML or AI model thereof, that is available for execution at the first network node.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates the Third Generation Partnership Project (3GPP) Long Term Evolution (LTE) Evolved Universal Terrestrial Radio Access Network (E-UTRAN) architecture;

FIG. 2 illustrates the 3GPP Fifth Generation (5G) Radio Access Network (RAN), or Next Generation RAN (NG-RAN), architecture;

FIG. 3 shows the Machine Learning (ML) components and terminologies as described in O-RAN Working Group 2, “AI/ML workflow description and requirements”, February 2021;

FIG. 4 illustrates a framework to support Artificial Intelligence (AI)/ML driven Radio Access Network (RAN) functionalities in 3GPP NG-RAN;

FIG. 5 illustrates one example of a cellular communications system in which embodiments of the present disclosure may be implemented;

FIG. 6 shows a non-limiting example of the operation of a first network node and a second network node in which these two network nodes exchange information for scaling, de-scaling, or formatting data associated to a ML/AI algorithm, or ML/AI model thereof, executed by the first network node in accordance with one embodiment of the present disclosure;

FIG. 7 illustrates step 606 of FIG. 6 in more detail, in accordance with one embodiment of the present disclosure;

FIGS. 8, 9, and 10 illustrate the operation of the first network node and the second network node in accordance with further non-limiting example embodiments of the present disclosure; and

FIGS. 11, 12, and 13 are schematic block diagrams of example embodiments of a network node in which embodiments of the present disclosure may be implemented.

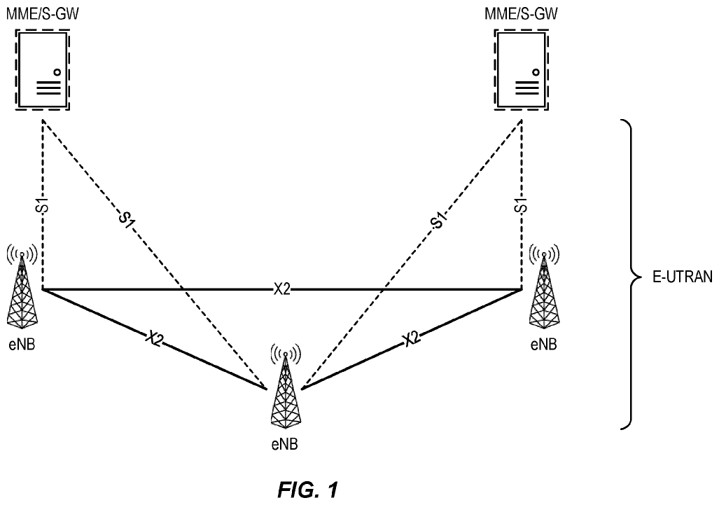

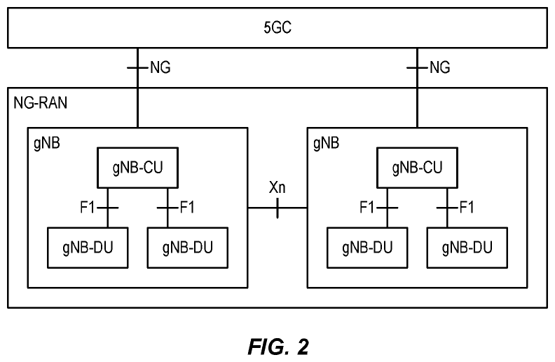

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). The optimization or updating Machine Learning (ML) and Artificial Intelligence (AI) algorithms, also known as training, requires careful scaling of the data samples that are fed to the training algorithm. This is required not only to reduce the training time and improve the learning rate, but also to avoid computational issues that may lead either to sub-optimal results or the inability of training the algorithm (e.g., divergence of the training algorithm). For instance, algorithms based on gradient techniques, such as gradient descent/ascent update, stochastic gradient descent (SGD), etc., are rather sensitive to the range of values used as input in each update step of the training algorithm.

However, different types of input data that can be simultaneously used to train a ML/AI algorithm (or a ML/AI model) can have rather different domains of values, which often can differ by several order of magnitudes. For example, some radio parameters measured by the base station of the UE may take large values. One example is the Signal to Interference plus Noise Ratio (SINR) whose values may range in, for instance, [0 10³] when expressed in linear scale or, e.g., in [−5, 35] decibels (dB) when expressed in logarithmic scale. Other radio parameters, on the other hand, may take very small values. Typical examples are, for instance, measurements of the Reference Signal Received Power (RSRP) or measurements of channel gain/loss due to different types of channel fading. Typical values of RSRP may range in the order of, for instance, [10⁻², 10⁻⁶] milliwatts (mW) when expressed in linear scale or, equivalently, [−120, −60] decibel-milliwatts (dBm) when expressed in logarithmic scale. Training an ML/AI algorithm with data samples having such variations in values would prevent the algorithm from learning from the values that have smaller granularity.

A common remedy in the ML/AI research field is to format the data, e.g., scale the data samples, prior to training. With different types of input data properly scaled around similar ranges of values, such algorithms are known to perform smother optimization, while with data ranging in very diverse order of magnitudes, such algorithms can easily diverge.

Scaling the data samples, and possibly the action space, used to train a ML/AI algorithm has several practical consequences:
Executing (i.e., inference) such algorithms requires the data provided as input to the algorithm to be scaled according to the same scaling criteria used for training the algorithm.
The output produced by such ML/AI algorithm is affected by the data scaling criteria used for the algorithm training, and therefore cannot be directly applied to the system without proper de-scaling.

Such consequences are typically not an issue in traditional applications of ML/AI algorithms, wherein training and execution of a ML/AI algorithm are typically co-located in the same machine. In a RAN, however, a ML/AI algorithm may be executed in a RAN node such as an eNB or gNB and trained in a different network node, such as Orchestration and Management (OAM) node, a core network node, or a server node in an external training facility. Therefore, a ML/AI trained for solving a RAN function, such as power control in uplink or downlink, coverage and capacity optimization, link adaptation, etc., may not be readily executed with the raw data as it is available to the RAN node. Similarly, the action produced by such ML/AI algorithm, such as an indication of a power adjustment in uplink or downlink, a coverage or capacity configuration for RAN cells, a set of link adaptation parameters for a UE, etc., may not be readily applicable to the system as the RAN node may not be able to map the output returned by the ML/AI algorithm to the proper scale or format.

Certain aspects of the present disclosure and their embodiments may provide solutions to the aforementioned or other challenges. According to at least some embodiments of the present disclosure, to properly execute a ML/AI algorithm (e.g., after a policy/model update received by another network node) and to properly interpret the output returned by the ML/AI algorithm for a given set of input information, it may be advantageous for the RAN node to be aware of the scaling criteria that needs to be applied to the data used as input to the ML/AI algorithm as well as the de-scaling or re-formatting criteria that needs to be applied to the output of the ML/AI algorithm before it is used in the RAN.

Systems and methods are disclosed herein for two network nodes to exchange information associated to data scaling and de-scaling that can be used for training and executing a ML/AI algorithm.

Systems and methods are disclosed herein for two network nodes to exchange information associated to data formatting, such as data scaling and de-scaling, associated to a ML/AI algorithm executed by the first network node, wherein such ML/AI algorithm or model thereof is trained and/or updated by the second network node.

Therefore, the systems and methods disclosed herein enable the first network node to properly format the input data provided to the ML/AI algorithm, or model thereof, prior to executing the ML/AI algorithm, as well as to properly interpret and format the output provided by the execution of the ML/AI algorithm, or ML/AI model thereof. The formatting information reflects how the training data has been formatted to train and/or update the ML/AI algorithm, or ML/AI model thereof.

Embodiments of a method executed by a first network node in a communication network for exchanging information for scaling, de-scaling, or formatting data associated to a ML/AI algorithm executed by the first network node are disclosed herein. In one embodiment, the method comprises:
receiving, at the first network node, a FIRST MESSAGE from a second network node, the FIRST MESSAGE comprising information associated to how to format data for executing at least a ML/AI algorithm, or a ML/AI model thereof, available at the first network node; and
executing the at least a ML/AI algorithm, or a ML/AI model thereof, available at the first network node by formatting data based on the formatting information comprised in the FIRST MESSAGE.

Additional signaling embodiments of the first network node may include:
transmitting a SECOND MESSAGE to the second network node, the SECOND MESSAGE comprising a request for information associated to how to format data for executing at least a ML/AI algorithm, or a ML/AI model thereof, available at the first network node (e.g., request for information associated to data scaling/de-scaling for at least a ML/AI algorithm executed by the first network node). Note that the SECOND MESSAGE may be transmitted prior to receiving the FIRST MESSAGE.

In one embodiment, this can be done prior to or upon receiving a model update.

Additional embodiments are disclosed herein that relate to the message formats of the FIRST MESSAGE and the SECOND MESSAGE and the information elements contained therein.

Embodiments of a method executed by a second network node in a communication network for exchanging information for scaling, de-scaling, or formatting data associated to a ML/AI algorithm executed by the first network node are also disclosed herein. In one embodiment, the method comprises:
transmitting a FIRST MESSAGE to the first network node, the FIRST MESSAGE comprising information associated to how to format data for executing at least a ML/AI algorithm, or a ML/AI model thereof, available at the first network node.

Additional signaling embodiments for the second network node may also include:
receiving a SECOND MESSAGE from the first network node, the SECOND MESSAGE comprising a request for information associated to how to format data for executing at least a ML/AI algorithm, or a ML/AI model thereof, available at the first network node (e.g., request for information associated to data scaling/de-scaling for at least a ML/AI algorithm executed by the first network node). Note that the SECOND MESSAGE may be received prior to transmitting the FIRST MESSAGE.

Certain embodiments may provide one or more of the following technical advantage(s). One advantage of embodiments of the solution disclosed herein is that a first network node is enabled to properly execute an AI/ML algorithm to optimize RAN functionalities and operations, to thereby improve performance, when the AI/ML algorithm has been trained by a second network node.

Another advantage of embodiment of the solution disclosed herein is to enable a first network node to properly interpret the result produced by an AI/ML algorithm when executed by the first network node, and therefore to correctly apply the results of the algorithm (i.e., act) to modify and optimize functionalities and operations when the AI/ML algorithm was trained by a second network node.

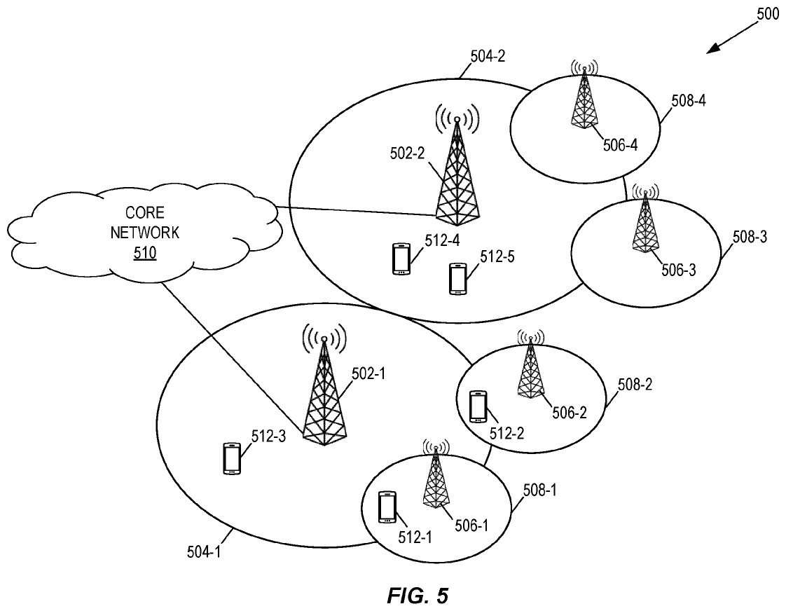

FIG. 5 illustrates one example of a cellular communications system 500 in which embodiments of the present disclosure may be implemented. In the embodiments described herein, the cellular communications system 500 is a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC); however, the present disclosure is not limited thereto. In this example, the RAN includes base stations 502-1 and 502-2, which in the 5GS include NR base stations (gNBs) and optionally next generation eNBs (ng-eNBs) (e.g., LTE RAN nodes connected to the 5GC) and in the EPS include eNBs, controlling corresponding (macro) cells 504-1 and 504-2. The base stations 502-1 and 502-2 are generally referred to herein collectively as base stations 502 and individually as base station 502. Likewise, the (macro) cells 504-1 and 504-2 are generally referred to herein collectively as (macro) cells 504 and individually as (macro) cell 504. The RAN may also include a number of low power nodes 506-1 through 506-4 controlling corresponding small cells 508-1 through 508-4. The low power nodes 506-1 through 506-4 can be small base stations (such as pico or femto base stations) or RRHs, or the like. Notably, while not illustrated, one or more of the small cells 508-1 through 508-4 may alternatively be provided by the base stations 502. The low power nodes 506-1 through 506-4 are generally referred to herein collectively as low power nodes 506 and individually as low power node 506. Likewise, the small cells 508-1 through 508-4 are generally referred to herein collectively as small cells 508 and individually as small cell 508. The cellular communications system 500 also includes a core network 510, which in the 5GS is the 5GC and in the EPS is the EPC. The base stations 502 (and optionally the low power nodes 506) are connected to the core network 510.

The base stations 502 and the low power nodes 506 provide service to wireless communication devices 512-1 through 512-5 in the corresponding cells 504 and 508. The wireless communication devices 512-1 through 512-5 are generally referred to herein collectively as wireless communication devices 512 and individually as wireless communication device 512. In the following description, the wireless communication devices 512 are oftentimes UEs and as such sometimes referred to herein as UEs 512, but the present disclosure is not limited thereto.

For the following description, the term “RAN node” or “network node” can refer to a RAN node or network node in the LTE or NR technology and may be one of an eNB, gNB, E-UTRA and NR dual connectivity gNB (en-gNB), next generation eNB (ng-eNB), Centralized Unit Control Plane (CU-CP), Centralized Unit User Plane (CU-UP), Distributed Unit (DU), gNB Centralized Unit (gNB-CU), gNB DU (gNB-DU), gNB CU-CP (gNB-CU-UP), gNB CU-CP (gNB-CU-CP), eNB Centralized Unit (eNB-CU), eNB DU (eNB-DU), eNB CU-UP (eNB-CU-UP), eNB CU-CP (eNB-CU-CP), Integrated Access Backhaul (IAB) node, IAB-donor DU, IAB-donor Centralized Unit (CU), IAB-DU, IAB Mobile Termination (IAB-MT), Open-RAN CU (O-CU), Open-RAN CU-CP (O-CU-CP), Open-RAN CU-UP (O-CU-UP), Open-RAN DU (O-DU), Open-RAN Radio Unit (O-RU), Open-RAN eNB (O-eNB).

Hereafter, the terms input data, input feature, input element, etc. are used interchangeably to refer to one input used by a ML/AI algorithm or a ML/AI model thereof. Examples may comprise the input data/elements/features of a neural network.

It should also be noted that the “ML/AI algorithm” can also be referred to herein as a “ML/AI process”. Thus, anywhere that the term “ML/AI algorithm” or similar term is used herein, that term should also be construed as meaning a “ML/AI process”. In other words, as used herein, the term “ML/AI algorithm” is not to be construed as a purely mathematical construct; rather the term “AL/AI algorithm” is to be construed as being an AL or MI process or procedure, which may include or be represented as a ML or AI model (e.g., a neural network).

Systems and methods are disclosed herein for two network nodes, which are referred to herein as a first network node and a second network node, to exchange information for scaling, de-scaling, or formatting data associated to a ML/AI algorithm executed by the first network node and trained by the second network node.

In this regard, embodiments of a method executed by a first network node in a communication network for exchanging information for scaling, de-scaling, or formatting data associated to a ML/AI algorithm executed by the first network node are disclosed herein. In one embodiment, the method comprising:
receiving a FIRST MESSAGE from a second network node, the FIRST MESSAGE comprising information associated to how to format data for executing at least a ML/AI algorithm, or a ML/AI model thereof, available at the first network node; and
executing at least a ML/AI algorithm, or a ML/AI model thereof, available at the first network node based on the formatting information received with the FIRST MESSAGE (e.g., by formatting data (e.g., input data and/or output data) based on the formatting information included in the FIRST MESSAGE).

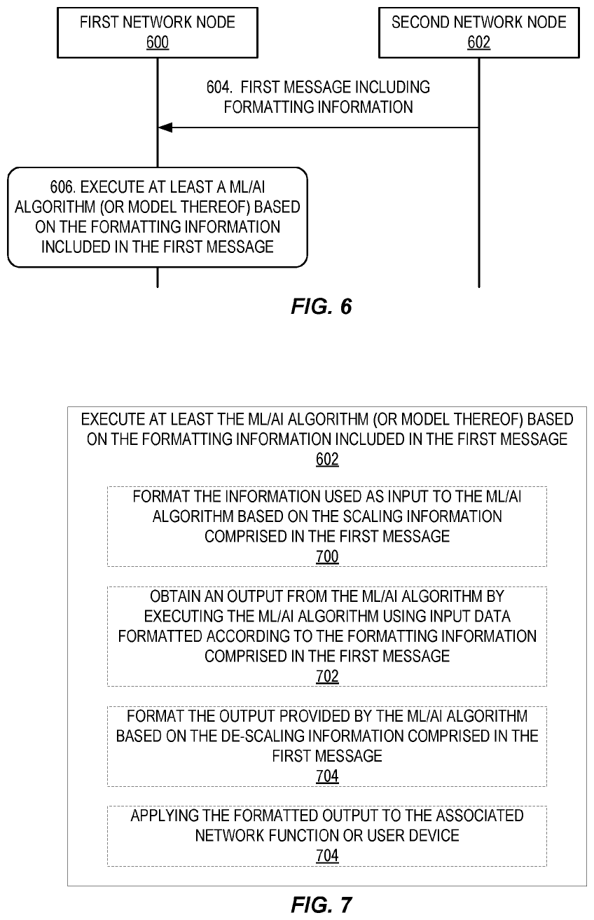

FIG. 6 shows a non-limiting example of the operation of a first network node 600 and a second network node 602 in which these two network nodes exchange information for scaling, de-scaling, or formatting data associated to a ML/AI algorithm, or ML/AI model thereof, executed by the first network node 600 in accordance with one embodiment of the present disclosure. Note that the MI/AL algorithm, or ML/AI model thereof, may be trained by the second network node 602. It should also be noted that in a communication network, such as a radio access network, there may not be a direct communication interface between the first network node 600 and the second network node 602. Therefore, the message transmitted by the second network node 602 to the first network node 602 may be relayed, forwarded, or routed by one or more other network nodes between the second network node 602 and the first network node 600. Thereby, in the context of the present disclosure, expressions such as, e.g., “receiving a message from” and/or “transmitting a message to” can be interpreted as the message is “receiving a message is generated by” and/or “transmitting a message that is addressed to”, while the message may pass through one or more intermediate network nodes. In one embodiment, the communication network is the RAN of the cellular communication system 500, where the first network node 600 is, e.g., a base station 502 or a network node that performs at least some of the functionality of the base station 502 and the second network node 602 is some other network node (e.g., a core network node in the core network 510, an OAM node, or a server node).

As illustrated in FIG. 6, the second network node 602 transmits a FIRST MESSAGE to the first network node 600, and the first network node 600 receives the FIRST MESSAGE from the second network node 602 (step 604). The FIRST MESSAGE comprises information associated to how to format data for executing at least a ML/AI algorithm, or a ML/AI model thereof, available at the first network node 600. The first network node 600 executes at least the ML/AI algorithm, or the ML/AI model thereof, available at the first network node 600 based on the formatting information comprised in the FIRST MESSAGE (e.g., by formatting data (e.g., input data and/or output data) based on the formatting information included in the FIRST MESSAGE) (step 606).

As illustrated in FIG. 7, in one embodiment, executing at least the ML/AI algorithm, or the ML/AI model thereof, at the first network node 606 based on the formatting information received with the FIRST MESSAGE may comprise:
(a) formatting the information used as input to the ML/AI algorithm based on scaling information comprised in formatting information comprised the FIRST MESSAGE (step 700);
(b) obtaining an output from the ML/AI algorithm by executing the ML/AI algorithm using input data formatted according to formatting information comprised the FIRST MESSAGE (step 702);
(c) formatting the output provided by the ML/AI algorithm based on de-scaling information comprised in formatting information comprised in the FIRST MESSAGE (step 704);
(d) applying the formatted output to the associated network function or communication device (step 706); or
(e) a combination of any two or more of (a)-(d).

In one embodiment, the FIRST MESSAGE comprises data formatting information associated to a ML algorithm, or model therefore, trained to optimize at least one network operation/function of the first network node 600. Non-liming examples of network operation/function of the first network node 600 that could benefit from the method are the optimization of coverage and/or capacity configurations for cells (or fractions thereof) controlled by the first network node 600, the optimization of load and traffic across the coverage area of its serving cells or fractions thereof (such as SSB beams coverage areas) as well as across serving cells or fractions thereof of neighboring network nodes, the optimization of mobility decision, the optimization of network-level energy savings operations (such as cell activation/deactivation, cell shaping, etc.)

In another embodiment, the FIRST MESSAGE comprises data formatting information associated to a ML algorithm, or model therefore, trained to optimize one or more operations or configurations associated to a communication device (e.g., a wireless communication device 512) connected to the first network node 600 (e.g., a communication device served by the first network node 600). Non-limiting examples of operations or configurations associated to communication devices that could benefit from the method include, for instance, energy savings configuration, such as discontinuous transmission and/or reception modes, link adaptation, Multiple Input Multiple Output (MIMO) configurations, channel estimation algorithms, channel state information estimation, etc.

In one embodiment, the FIRST MESSAGE may comprise one or more information elements associated to how to format data for executing at least a ML/AI algorithm, or a ML/AI model thereof, available at the first network node 600, where these one or more information elements include:
(a) an indication of at least a data scaling and/or descaling criterion (or function or operation), such as a linear or non-linear scaling and/or descaling criterion (or function or operation), to be applied for at least one input data (or input element) of the ML/AI algorithm or the ML/AI model thereof;
(b) an indication of at least a data format to be applied for at least one input data (or input element) of the ML/AI algorithm or the ML/AI model thereof;
(c) an indication of at least a data scaling and/or de-scaling criterion (or function or operation), such as a linear or non-linear scaling and/or descaling criterion (or function or operation), to be applied for at least one output data (or output element) of the ML/AI algorithm or the ML/AI model thereof;
(d) an indication of at least a data format to be used for at least one output data (or output element) of the ML/AI algorithm or the ML/AI model thereof;
(e) an indication of at least a normalization criterion (or a function or operation) to be applied for at least one input data (or input element) of the ML/AI algorithm or the ML/AI model thereof;
(f) an indication of at least a normalization criterion (or a function or operation) to be applied for at least one output data (or output element) of the ML/AI algorithm or the ML/AI model thereof;
(g) an indication of at least one parameter to be utilized in the normalization (function) to be applied for at least one input data (or input element) and/or to an output data (or output element) of the ML/AI algorithm or the ML/AI model thereof; Examples include mean and/or variance parameters (or other statistical information), associated to individual input data elements and/or output data elements, to be utilized in the normalization function; or
(h) a combination of any two or more of (a)-(g).

According to some embodiments of the present disclosure, the first network node 600 may, in the FIRST MESSAGE, receive information associated to formatting one or more input data (or input elements) and/or one or more output data (or output elements) of a ML/AI algorithm, or a ML/AI model thereof, available at the first network node 600. In one embodiment, in step 606, the first network node 600 may therefore execute the at least one ML/AI algorithm, or a ML/AI model thereof, by formatting at least one input data or at least one output data of the ML algorithm, or the ML/AI model thereof, based on the formatting information included in the FIRST MESSAGE.

In one example, the FIRST MESSAGE received by the first network node 600 may indicate a linear scaling function to be utilized by the first network node 600 for at least one input data (or input element) and/or at least one output data (or output element) of a ML/AI algorithm, or the ML/AI model thereof, available at the first network node 600, wherein the indicated scaling function is:

$$\hat{x} = \hat{L} + \frac{x - L}{U - L} \times ( \hat{U} - \hat{L} ) .$$

In this expression,
x denotes either an input data (or input element) and/or at least one output data (or output element) of the ML algorithm, or the ML/AI model thereof, of the first network node,
\hat{x} denotes the respective scaled version,
L and U denote a minimum (or lower bound) value and a maximum (or upper bound) value, respectively, for x. Thereby the value of x ranges in the interval x∈[L, U],
\hat{L} and Û denote a target minimum (or lower bound) value and a target maximum (or upper bound) value, respectively, for z. Thereby, the scaled version of input information ranges in the interval z E [\hat{L}, Û].

In another example, the FIRST MESSAGE received by the first network node 600 indicates a normalization function associate to at least one input data (or input element) and/or at least one output data (or output element) of a ML algorithm, or the ML/AI model thereof, available at the first network node 600, wherein the indicated scaling function is:

$$f ( x ) = \frac{γ ( x - E ( x ) )}{\sqrt{var ( x ) + ϵ}} + β .$$

In this expression:
E(x) denotes the mean of associated to the input data (or output data) x when computed over a set of samples of x,
var(x) denotes the variance of associated to the input data (or output data) x when computed over a set of samples of x, and
γ, β and ϵ are constant real numbers (which introduce scaling, biases, and numerical stability, respectively to the input data) and are provided from the second network node.

In this example, the parameters γ, β and ϵ can be provided by the FIRST MESSAGE, whereas the mean and variance E(x) and var(x) could be either calculated by the first network node 600 based on a set of samples of input data (or output data) x or can be also provided by the FIRST MESSAGE (as exemplified in the following embodiments).

In one embodiment, the one or more information elements included in the FIRST MESSAGE that are associated to how to format data for executing at least a ML/AI algorithm or a ML/AI model thereof available at the first network node 600 may further comprise:
(a) an indication of at least a maximum value or an upper bound value associated to at least one input data used for the ML/AI algorithm or the ML/AI model thereof;
(b) an indication of at least a minimum value or a lower bound value associated to at least one input data used for the ML/AI algorithm or the ML/AI model thereof;
(c) an indication of at least one statistical momentum, such as an average, a standard deviation, a variance, associated to at least one input data used for the ML/AI algorithm or the ML/AI model thereof; (d) an indication of at least a maximum value or an upper bound value associated to at least one output element of the ML/AI algorithm or the ML/AI model thereof;
(e) an indication of at least a minimum value or a lower bound value associated to at least one output element of the ML/AI algorithm or the ML/AI model thereof;
(f) an indication of at least one statistical momentum, such as an average, a standard deviation, a variance, associated to at least one output element of the ML/AI algorithm or the ML/AI model thereof;
(g) an indication of at least one bias and/or scaling parameter, such as constant real numbers to transform the distribution of at least one input or output element of the ML/AI algorithm or the ML/AI model thereof; or
(h) a combination of any two or more of (a)-(h).

In one embodiment, the FIRST MESSAGE may indicate that the data formatting information already available at the first network node 600 is still valid. Additionally, the FIRST MESSAGE may further indicate:
(a) an extended validity period, such as a time period, associated to the data formatting information available at the first network node 600;
(b) a level of accuracy associated to the data formatting information available at the first network node 600;
(c) an indication of an expected performance degradation associated to the data formatting information available at the first network node 600; or
(d) a combination of any two or more of (a)-(c).

In one example, the second network node 602 may, via the FIRST MESSAGE, indicate that the data formatting information available at the first network node 600 associated to a ML/AI algorithm, or ML/AI model thereof, is still valid. However, the second network node 602 may indicate that continuing use of such data formatting information may come with an expected performance degradation. This may happen if the second network node 602 has available a new set of data formatting information that could be used for the ML/AI algorithm, or model thereof, available at the first network node 600, however the update to the formatting information is not significant enough (e.g., it does not exceed a threshold value) that the first network node 600 can continue using the already available data formatting information.

In one embodiment, the ML/AI algorithm executed by the first network node 600, or at least an AI/ML model that is part of the AI/ML algorithm, is trained and/or updated by the second network node 602. Thus, in one embodiment, the FIRST MESSAGE transmitted from the second network node 602 and received by the first network node 600 further comprises the ML/AI algorithm and/or ML/AI model trained or updated by the second network node 602. As will be understood by one of ordinary skill in the art, according to embodiments, when referring to that ML models are provided between network nodes, or between other entities in a RAN network, what is considered is that the models are being transmitted, or signaled. An ML model may for example be signaled using existing model formats such as Open Neural Network Exchange (ONNX), or formats commonly used in ML toolboxes such as Keras or Pytorch. The ONNX format supports different types of NNs architectures such as convolutional NN, recurrent NN, etc., but is assuming that models are expressed as tensors for a NNs, which does have its restrictions in terms of expressiveness. Another alternative could for instance be to use a serialized Python class (as is typical in scikit-learn and joblib.dump). According to embodiments, a model could be signaled using a high-level model description, plus a detailed information regarding for example the weights of each layer of the NN. According to other embodiments, a model could be signaled by transmitting a model parameter vector. A NN model parameter vector may for example comprise parameters defining the structure and characteristics of the model, such as for example number of layers, activation function of respective layer, nature of connections between nodes of respective layer, weights, loss function, just to mention a few.

Non-limiting examples of ML/AI models that may be part of a ML/AI algorithm are functional approximation models, such as feedforward neural networks, deep neural networks, recurrent neural networks, convolutional neural networks, decision trees, decision forests, etc. Therefore, the first network node 600 may receive, in addition to information associated to formatting the input data and/or the output of the ML/AI algorithm or the ML/AI model thereof, a newly trained or updated ML/AI algorithm or the respective ML/AI model to which the scaling, de-scaling, or formatting is to be applied by the first network node 600.

As another example, linear/nonlinear binary/multi-class classifiers, linear/nonlinear regression models can be used as models in a ML/AI algorithm. As such, the first network node 600 may receive, in addition to the information associated to formatting the input data and/or the output of the ML/AI algorithm or the ML/AI model thereof, a new set of parameters/weights characterizing the mentioned ML/AI models or update an existing model therein to which the scaling, de-scaling, or formatting of data is to be applied by the first network node 600.

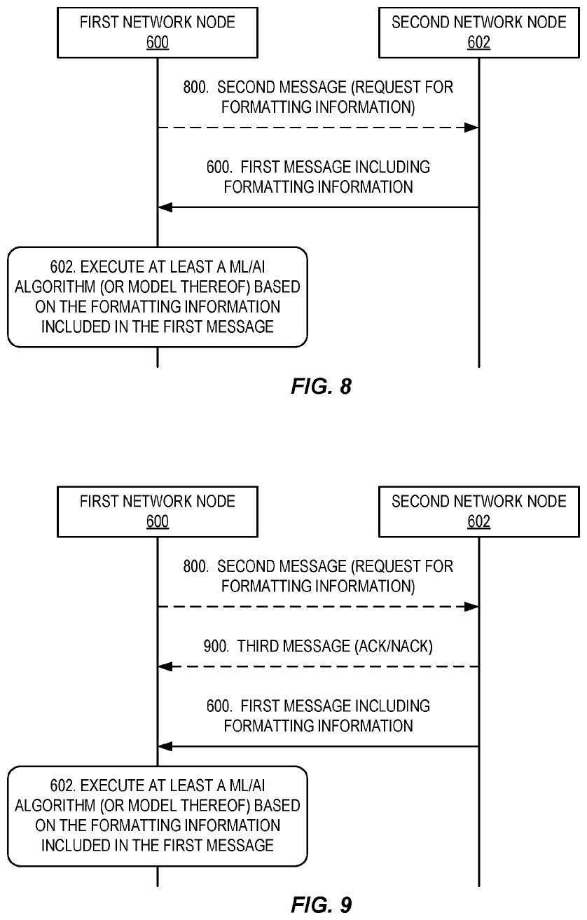

In one embodiment, as illustrated in FIG. 8, the first network node 600 may additionally transmit a SECOND MESSAGE to the second network node 602, the SECOND MESSAGE comprising a request for information associated to how to format data for executing at least a ML/AI algorithm, or a ML/AI model thereof, available at the first network node (step 800).

The first network node 600 may therefore proactively send a request to the second network node 602 for information associated to how to format data for executing at least a ML/AI algorithm, or a ML/AI model thereof, available at the first network node 600. The first network node 600 would need such information to correctly execute the ML/AI algorithm, or ML/AI model thereof, when such ML/AI algorithm or model is trained or updated by the second network node.

Therefore, in one embodiment, the SECOND MESSAGE may comprise:
(a) a request for at least a data scaling and/or descaling criterion (or function or operation), such as a linear or non-linear scaling and/or descaling criterion (or function or operation), to be applied for at least one input data (or input element) of the ML/AI algorithm or the ML/AI model thereof:
(b) a request for at least a data format to be applied for at least one input data (or input element) of the ML/AI algorithm or the ML/AI model thereof;
(c) a request for at least a data scaling and/or de-scaling criterion (or function or operation), such as a linear or non-linear scaling and/or descaling criterion (or function or operation), to be applied for at least one output data (or output element) of the ML/AI algorithm or the ML/AI model thereof;
(d) a request for at least a data format to be used for at least one output data (or output element) of the ML/AI algorithm or the ML/AI model thereof;
(e) a request for at least a normalization criterion (or a function or operation) to be applied for at least one input data (or input element) of the ML/AI algorithm or the ML/AI model thereof;
(f) a request for at least a normalization criterion (or a function or operation) to be applied for at least one output data (or output element) of the ML/AI algorithm or the ML/AI model thereof;
(g) a request for at least one parameter to be utilized in the normalization (function) to be applied for at least one input data (or input element) and/or to an output data (or output element) of the ML/AI algorithm or the ML/AI model thereof; Examples include mean and/or variance parameters (or other statistical information), associated to individual input data elements and/or output data elements, to be utilized in the normalization function; or
(h) a combination of any two or more of (a)-(h).

Therefore, the first network node 600 may send a request to the second network node 602 for information associated to formatting one or more input data (or input elements) and/or one or more output data (or output elements) of a ML/AI algorithm, or a ML/AI model thereof, available at the first network node 600. The requested information may be, in certain cases, one or more criterion, functions, or operations to be applied to scale data or information elements prior to executing the ML/AI algorithm or model thereof, or to descale data or information elements upon the execution of the ML/AI algorithm or model thereof.

In one embodiment, the SECOND MESSAGE may comprise a request for one or more formatting parameters associated to a ML/AI algorithm, or a ML/AI model thereof, available at the first network node 600. In this embodiment, the SECOND MESSAGE includes:
(a) a request for at least a maximum value or an upper bound value associated to at least one input data used for the ML/AI algorithm or the ML/AI model thereof;
(b) a request for at least a minimum value or a lower bound value associated to at least one input data used for the ML/AI algorithm or the ML/AI model thereof;
(c) a request for at least one statistical momentum, such as an average, a standard deviation, a variance, associated to at least one input data used for the ML/AI algorithm or the ML/AI model thereof;
(d) a request for at least a maximum value or an upper bound value associated to at least one output element of the ML/AI algorithm or the ML/AI model thereof;
(e) a request for at least a minimum value or a lower bound value associated to at least one output element of the ML/AI algorithm or the ML/AI model thereof;
(f) a request for at least one statistical momentum, such as an average, a standard deviation, a variance, associated to at least one output element of the ML/AI algorithm or the ML/AI model thereof:
(g) a request for at least one bias and/or scaling parameter, such as constant real numbers to transform the distribution of at least one input or output element of the ML/AI algorithm or the ML/AI model thereof; or
(h) a combination of any two or more of (a)-(g).

In one embodiment, the SECOND MESSAGE may comprise one or more instructions and/or events and/or conditions for reporting of assistance information associated to formatting data for at least a ML/AI algorithm, or ML/AI model thereof, available at the first network node. The one or more instructions and/or events and/or conditions may include:
(a) A list of instructions to start, stop, pause, resume, or modify the reporting of assistance information associated to formatting data for at least a ML/AI algorithm, or ML/AI model thereof, available at the first network node 600;
(b) A list of at least one ML/AI algorithms and/or models thereof, for which reporting of data formatting from the second network node is requested. In one example, a ML/AI algorithm, or a model thereof, available at the first network node 600, may be associated with a unique identifier which may be known at the second network node 602. Therefore, the first network node 600 may use such identifier to indicate for which ML/AI algorithm, or ML/AI model thereof, requests data formatting information to the second network node 602.
(c) A reporting periodicity
(d) A one-time reporting
(e) A reporting criteria, such as:
   (i) Upon an update or retrain of the indicated ML/AI algorithm(s), or ML/AI model(s) thereof, done by the second network node 602.
   (ii) Upon a change in the formatting criteria, such as a scaling criteria or a descaling criteria, associated to at least one of the indicated ML/AI algorithm(s), or ML/AI model(s) thereof.
   (iii) If the maximum value of a data set associated to at least one data input (or input data elements for at least one of the indicated ML/AI algorithm(s), or ML/AI model(s) thereof, exceeds or falls below a threshold value.
   (iv) If the minimum value of a data set associated to at least one data input (or input data element) for at least one of the indicated ML/AI algorithm(s), or ML/AI model(s) thereof, exceeds or falls below a threshold value.
   (v) If the average value of a data set associated to at least one data input (or input data element) for at least one of the indicated ML/AI algorithm(s), or ML/AI model(s) thereof, exceeds or falls below a threshold value.
   (vi) If the variance of a data set associated to at least one data input (or input data element) for at least one of the indicated ML/AI algorithm(s), or ML/AI model(s) thereof, exceeds or falls below a threshold value.
   (vii) If the minimum of values associated to at least one data input (or data element) for at least one of the indicated ML/AI algorithm(s), or ML/AI model(s) thereof, exceeds or falls below a first threshold.
   (viii) If the minimum of values associated to at least one output (or output element) for at least one of the indicated ML/AI algorithm(s), or ML/AI model(s) thereof, exceeds or falls below a first threshold
   (ix) If the minimum value of a data set associated to at least one output (or output element) for at least one of the indicated ML/AI algorithm(s), or ML/AI model(s) thereof, exceeds or falls below a threshold value.
   (x) If the average value of a data set associated to at least one output (or output element) for at least one of the indicated ML/AI algorithm(s), or ML/AI model(s) thereof, exceeds or falls below a threshold value.
   (xi) If the variance of a data set associated to at least one output (or output element) for at least one of the indicated ML/AI algorithm(s), or ML/AI model(s) thereof, exceeds or falls below a threshold value.
   (xii) If the minimum of values associated to at least one output (or output element) for at least one of the indicated ML/AI algorithm(s), or ML/AI model(s) thereof, exceeds or falls below a first threshold.

In one embodiment, as illustrated in FIG. 9, the second network node 602 may additionally send, and the first network node 600 may additionally receive, a THIRD MESSAGE in response to the SECOND MESSAGE (step 900). The THIRD MESSAGE comprises:
a positive acknowledgement (ACK) indicating a successful or partly successful initialization of a reporting procedure for exchanging data formatting information associated to at least one ML/AI algorithm, or ML/AI model thereof, available at the first network node 600; or
a negative acknowledgement (NACK) indicating a failure to initialize a reporting procedure for exchanging data formatting information associated to at least one ML/AI algorithm, or ML/AI model thereof, available at the first network node 600.

Therefore, in response to the SECOND MESSAGE, the second network node 602 may transmit a THIRD MESSAGE to the first network node 600, where:
In one case, the THIRD MESSAGE may indicate which data formatting information requested by the first network node 600 via the SECOND MESSAGE can be provided by the second network node 602.

Additionally, the THIRD MESSAGE may comprise an indication of how the second network node 600 is to report the requested data formatting information, such as periodically, a-periodically, on event based, with what frequency in time, etc.
In another case, the THIRD MESSAGE may indicate that data formatting information requested by the first network node 600 via the SECOND MESSAGE cannot be provided by the second network node 602. In this case, the THIRD MESSAGE may additionally comprise a cause.

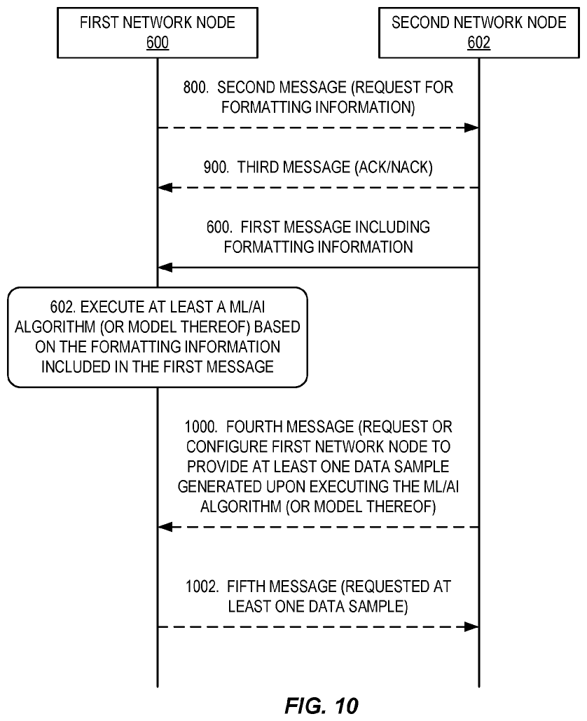

As illustrated in FIG. 10, in one embodiment, the second network node 602 may additionally transmit, and the first network node 600 may additionally receive a FOURTH MESSAGE, where the FOURTH MESSAGE requests or configures the first network node 600 to provide at least a data sample generated by the first network node 600 upon executing the ML/AI algorithm, or a ML/AI model thereof, available at the first network node 600 based on the formatting information comprised in the FIRST MESSAGE (step 1000).

Therefore, the second network node 602 may request the first network node 600 to provide a feedback comprising samples of how the first network node 600 has formatted one or more input data (or input data elements) to execute a ML/AI algorithm, or a ML/AI model thereof, based on the data formatting information comprised in the FIRST MESSAGE. Additionally, the first network node 600 may be requested to provide at least one sample of how the first network node 600 has formatted at least one output data (or output element) upon the execution of the ML/AI algorithm, or a ML/AI model thereof. The output elements could be provided in the format returned by the ML/AI algorithm, or a ML/AI model thereof, and/or upon formatting the output elements based on the formatting information comprised in the FIRST MESSAGE. The second network node 602 can therefore use such feedback to determine whether the first network node 600 can correctly format the input and/or the output data associated to at least a ML/AI algorithm, or a ML/AI model thereof, available at the first network node 600. In one case, the at least one ML/AI algorithm, or a ML/AI model thereof, is trained or updated by the second network node 602, thereby allowing the second network node 602 to verify whether the first network node 600 correctly executes the at least one ML/AI algorithm, or a ML/AI model thereof.

In one embodiment, the first network node 600 may additionally transmit, and the second network node 602 may additionally receive, a FIFTH MESSAGE (step 1002). The FIFTH MESSAGE comprises the at least one data sample generated by the first network node upon executing a ML/AI algorithm, or a ML/AI model thereof, available at the first network node 600 based on the data the formatting information received with the FIRST MESSAGE. Note that, in one embodiment, both steps 1000 and 1002 are performed, In another embodiment, only step 1002 is performed (i.e., the at least one data sample is sent to the second network node 602 without first receiving a request).

In one embodiment, the least one data sample requested in the FOURTH MESSAGE and/or the at least one data sample included in the FIFTH MESSAGE comprises: (a) a data sample associated to the execution of the ML or AL algorithm, or the ML or AL model thereof, prior to using the information about how the data is to be formatted comprised in the first message, (b) a data sample associated to the execution of the ML or AL algorithm, or the ML or AL model thereof, when using the information about how the data is to be formatted comprised in the first message, or (c) both (a) and (b). In one embodiment, the least one data sample requested in the FOURTH MESSAGE and/or the at least one data sample included in the FIFTH MESSAGE comprises: (a) at least one input data to the ML or AL algorithm, or the ML or AL model thereof, (b) at least one output data provided by the ML or AL algorithm, or the ML or AL model thereof, or (c) both (a) and (b).

In one embodiment, the first network node 600 could be a radio access network (RAN) node, such as an enhanced Node B (eNB) of an LTE or LTE-A system, a NG-RAN node of an NG-RAN systems (also knowns as gNB), or similar, In another example, the first network node 600 may also be a logical node within a RAN node, such as a distributed unit of an NG-RAN node (i.e., a gNB-DU). In another example, the first network 600 node could be an orchestration and management (OAM) node, a Service Management and Orchestration (SMO), a core network node, such as a Packet switched Core network Nodes (PCN), or a node external to the radio access network, such as a server node etc.

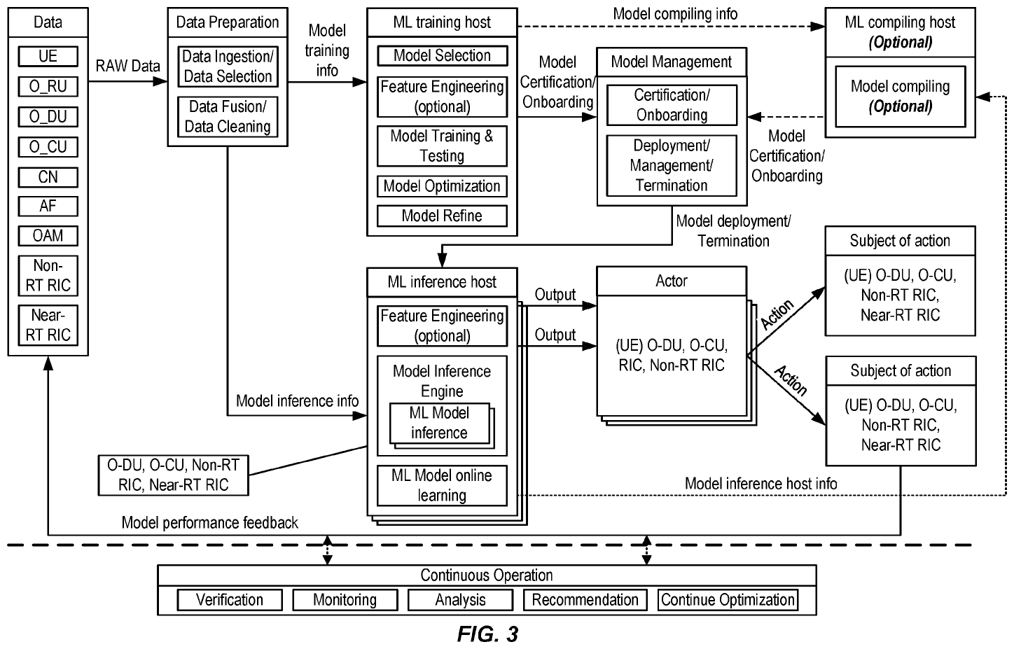

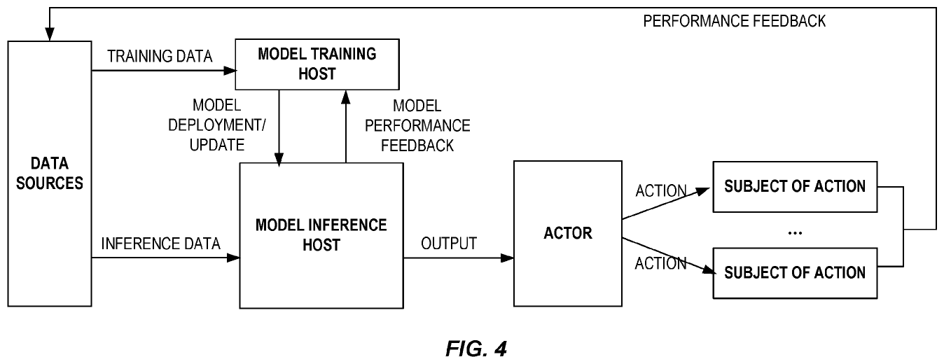

In one embodiment, in reference to the functional framework discussed in ORAN and/or 3GPP standardization bodies, and illustrated in FIG. 3 and FIG. 4, respectively:
The first network node 600 could be, for instance, a network node responsible for one or more of the following functions:
   Model inference
   Action
   Actor
   Real-time RIC
   Non-real-time RIC
The second network node 602 could be, for instance a network node responsible for one or more of the following functions:
   Data and/or data Collection
   Data Preparation
   Data source
   Model training/model training host
   Model management
   Non-real-time RIC

In one example, the first network node 600 is a RAN node (such as, e.g., eNB, or a gNB) or a logical node within a RAN node (such as, e.g., a gNB-CU, gNB-CU-CP, gNB-DU, etc.) while the second network node 602 is a node external to the radio access network, such as an OAM, SMO, or an external server. Therefore, exchanging messages between the first network node 600 and the second network node 602 may require communicating with intermediate nodes over different interfaces, such, e.g.,
The X2, Xn, F1, E1, S1, NG, other interfaces defined for the 3GPP LTE and NG-RAN systems.
The AI, F1, E1, E2 or other interfaces of the ORAN system.

Embodiments of a method executed by a second network node (e.g., the second network node 602) in a communication network for exchanging information for scaling, de-scaling or formatting data associated to a ML/AI algorithm executed by the first network node (e.g., the first network node 600) are also disclosed herein. In one embodiment, the method comprises:
transmitting a FIRST MESSAGE to the first network node, the FIRST MESSAGE comprising information associated to how to format data for executing for at least a ML/AI algorithm, or a ML/AI model thereof, available at the first network node.

In one embodiment, the second network node may additionally:
receive a SECOND MESSAGE from the first network node, the SECOND MESSAGE comprising a request for information associated to how to format data for executing at least a ML/AI algorithm, or a ML/AI model thereof, available at the first network node.

It should be noted that the names used for the messages exchanged between the first network node 600 and the second network node 602 do not imply any chronological order. In one example, for instance, the first network node 600 receives the SECOND MESSAGE prior to transmitting the FIRST MESSAGE. In this case, the method may further comprise the steps of:
determining one or more information associated to how to format data for executing at least a ML/AI algorithm, or a ML/AI model thereof, available at the first network node based on the SECOND MESSAGE; and
transmitting the FIRST MESSAGE to the first network node, the FIRST MESSAGE comprising the data formatting information determined based on the SECOND MESSAGE.

Therefore, the second network node 602 may determine and transmit one or more information associated to how to format data for executing at least a ML/AI algorithm available at the first network node based on one or more formatting information requested by the first network node 600 with the SECOND MESSAGE. Additional embodiments related to data formatting information that the first network node 600 may request to the second network node 602 are described above.

In one embodiment, upon receiving the SECOND MESSAGE from the first network node, the second network node may additionally:
transmit the FIRST MESSAGE to the first network node based on one or more instructions comprised in the SECOND MESSAGE.

Additional embodiments related to instructions for transmitting data formatting information requested by the first network node 600 are described above.

Additional signaling embodiments for the second network node may comprise any one or more of the following steps:
transmitting a THIRD MESSAGE to the first network node, in response to the SECOND MESSAGE, the THIRD MESSAGE comprising either:
   a positive acknowledgement (ACK) indicating; or
   a negative acknowledgment (NACK) indicating a failure to initialize a reporting procedure for exchanging data formatting information associated to at least one ML/AI algorithm, or ML/AI model thereof, available at the first network node.
transmitting a FOURTH MESSAGE to the first network node, the FOURTH MESSAGE requesting or configuring the first network node to provide a at least a data sample generated by the first network node upon executing a ML/AI algorithm, or a ML/AI model thereof, available at the first network node based on the data the formatting information received with the FIRST MESSAGE;
receiving a FIFTH MESSAGE from the first network node, the FIFTH MESSAGE comprising a at least a data sample generated by the first network node upon executing a ML/AI algorithm, or a ML/AI model thereof, available at the first network node based on the data the formatting information received with the FIRST MESSAGE.

Additional embodiments describing the THIRD, FOURTH, and FIFTH messages can be found above.

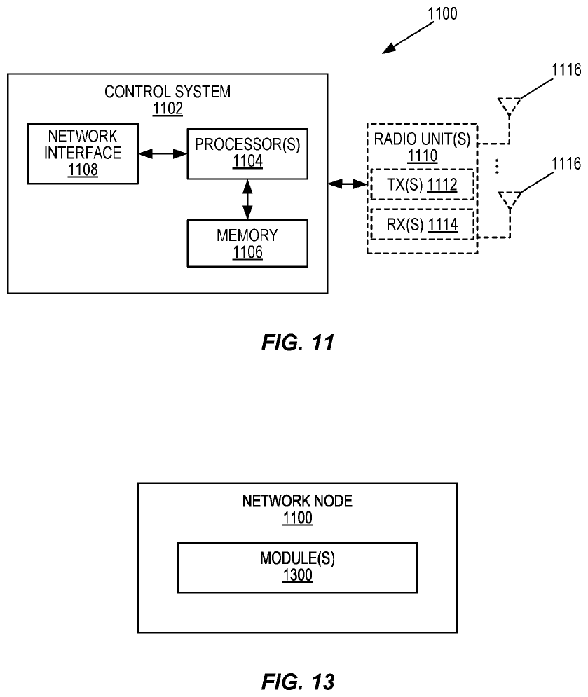

FIG. 11 is a schematic block diagram of a network node 1100 according to some embodiments of the present disclosure. Optional features are represented by dashed boxes. The network node 1100 may be, for example, the first network node 600 or the second network node 602. As illustrated, the network node 1100 includes a control system 1102 that includes one or more processors 1104 (e.g., Central Processing Units (CPUs), Application Specific Integrated Circuits (ASICs), Field Programmable Gate Arrays (FPGAs), and/or the like), memory 1106, and a network interface 1108. The one or more processors 1104 are also referred to herein as processing circuitry. In addition, if the network node 1100 is a RAN node, the network node 1100 may include one or more radio units 1110 that each includes one or more transmitters 1112 and one or more receivers 1114 coupled to one or more antennas 1116. The radio units 1110 may be referred to or be part of radio interface circuitry. In some embodiments, the radio unit(s) 1110 is external to the control system 1102 and connected to the control system 1102 via, e.g., a wired connection (e.g., an optical cable). However, in some other embodiments, the radio unit(s) 1110 and potentially the antenna(s) 1116 are integrated together with the control system 1102. The one or more processors 1104 operate to provide one or more functions of the network node 1100 as described herein (e.g., one or more functions of the first network node 600 or the second network node 602 as described herein). In some embodiments, the function(s) are implemented in software that is stored, e.g., in the memory 1106 and executed by the one or more processors 1104.

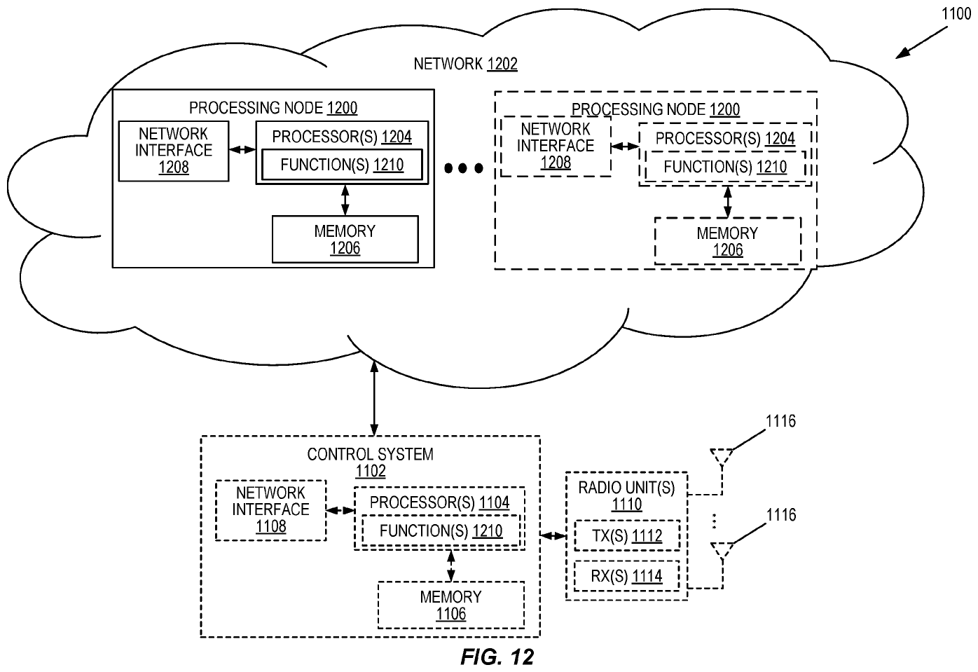

FIG. 12 is a schematic block diagram that illustrates a virtualized embodiment of the network node 1100 according to some embodiments of the present disclosure. Again, optional features are represented by dashed boxes. As used herein, a “virtualized” network node is an implementation of the network node 1100 in which at least a portion of the functionality of the network node 1100 is implemented as a virtual component(s) (e.g., via a virtual machine(s) executing on a physical processing node(s) in a network(s)). As illustrated, the radio access node 1100 includes one or more processing nodes 1200 coupled to or included as part of a network(s) 1202. Each processing node 1200 includes one or more processors 1204 (e.g., CPUs, ASICs, FPGAs, and/or the like), memory 1206, and a network interface 1208. If the network node 1100 is a radio access node, the network node 1100 may include the control system 1102 and/or the one or more radio units 1110, as described above. The control system 1102 may be connected to the radio unit(s) 1110 via, for example, an optical cable or the like. If present, the control system 1102 or the radio unit(s) are connected to the processing node(s) 1200 via the network 1202.

In this example, functions 1210 of the network node 1100 described herein (e.g., one or more functions of the first network node 600 or the second network node 602 as described herein) are implemented at the one or more processing nodes 1200 or distributed across the one or more processing nodes 1200 and the control system 1102 and/or the radio unit(s) 1110 in any desired manner. In some particular embodiments, some or all of the functions 1210 of the network node 1100 described herein are implemented as virtual components executed by one or more virtual machines implemented in a virtual environment(s) hosted by the processing node(s) 1200. As will be appreciated by one of ordinary skill in the art, additional signaling or communication between the processing node(s) 1200 and the control system 1102 is used in order to carry out at least some of the desired functions 1210. Notably, in some embodiments, the control system 1102 may not be included, in which case the radio unit(s) 1110 communicate directly with the processing node(s) 1200 via an appropriate network interface(s).

In some embodiments, a computer program including instructions which, when executed by at least one processor, causes the at least one processor to carry out the functionality of the network node 1100 or a node (e.g., a processing node 1200) implementing one or more of the functions 1210 of the network node 1100 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 13 is a schematic block diagram of the network node 1100 according to some other embodiments of the present disclosure. The network node 1100 includes one or more modules 1300, each of which is implemented in software. The module(s) 1300 provide the functionality of the network node 1100 described herein (e.g., one or more functions of the first network node 600 or the second network node 602 as described herein). This discussion is equally applicable to the processing node 1200 of FIG. 12 where the modules 1300 may be implemented at one of the processing nodes 1200 or distributed across multiple processing nodes 1200 and/or distributed across the processing node(s) 1200 and the control system 1102.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc.

Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

Embodiment 1: A method performed by a first network node (600), the method comprising: receiving (604) a first message from a second network node (602), the first message comprising information about how to format data for execution of at least a ML or AI algorithm, or ML or AI model thereof, that is available for execution at the first network node (600); and executing (606) the at least a ML or AI algorithm, or the ML or AI model thereof, based on the information comprised in the first message.

Embodiment 2: The method of embodiment 1 wherein the ML or AI algorithm, or the ML or AI model thereof, is trained at the second network node (602) and provided to the first network node (600) (e.g., in the first message together with the information about how to format data) for execution.

Embodiment 3: The method of embodiment 1 or 2 wherein executing (606) the at least a ML or AI algorithm, or the ML or AI model thereof, based on the information comprised in the first message comprises formatting at least one input data provided to the ML or AL algorithm, or the ML or AI model thereof, and/or at least one output data provided by the ML or AL algorithm, or the ML or AI model thereof, based on the information comprised in the first message.

Embodiment 4: The method of any of embodiments 1 to 3 wherein executing (606) the at least a ML or AI algorithm, or the ML or AI model thereof, based on the information comprised in the first message comprises: (a) formatting (700) information used as input to the ML or AI algorithm, or the ML or AI model thereof, based on scaling information comprised in the information comprised the first message; (b) obtaining (702) an output from the ML or AI algorithm, or the ML or AI model thereof, by executing the ML or AI algorithm, or the ML or AI model thereof, using input data formatted according to the information comprised in the first message; (c) formatting (704) an output provided by the ML or AI algorithm, or the ML or AI model thereof, based on de-scaling information comprised in the formatting information comprised in the first message; (d) applying (706) an output provided by the ML or AI algorithm, or the ML or AI model thereof, that is formatted according to the information comprised in the first message to an associated network function or communication device; or (e) a combination of any two or more of (a)-(d).

Embodiment 5: The method of any of embodiments 1 to 4 wherein the ML or AI algorithm, or the ML or AI model thereof, is trained to optimize one or more operations or functions of the first network node (600) or to optimize one or more operations or configurations associated to a communication device connected to the first network node (600).

Embodiment 6: The method of any of embodiments 1 to 5 wherein the information comprised in the first message comprises: (a) an indication of at least a data scaling and/or descaling criterion (or function or operation) to be applied for at least one input data of the ML or AI algorithm, or the ML or AI model thereof; (b) an indication of at least a data format to be applied for at least one input data of the ML or AI algorithm, or the ML or AI model thereof; (c) an indication of at least a data scaling and/or de-scaling criterion (or function or operation) to be applied for at least one output data of the ML or AI algorithm, or the ML or AI model thereof; (d) an indication of at least a data format to be used for at least one output data of the ML or AI algorithm, or the ML or AI model thereof; (e) an indication of at least a normalization criterion (or a function or operation) to be applied for at least one input data of the ML or AI algorithm, or the ML or AI model thereof; (f) an indication of at least a normalization criterion (or a function or operation) to be applied for at least one output data of the ML or AI algorithm, or the ML or AI model thereof; (g) an indication of at least one parameter to be utilized in a normalization (function) to be applied for at least one input data and/or to an output data of the ML or AI algorithm, or the ML or AI model thereof; or (h) a combination of any two or more of (a)-(g).

Embodiment 7: The method of any of embodiments 1 to 6 wherein the information comprised in the first message comprises information that indicates a linear scaling function to be utilized by the first network node (600) to scale at least one input data the ML or AI algorithm, or the ML or AI model thereof, and/or to descale at least one output data the ML or AI algorithm, or the ML or AI model thereof.

Embodiment 8: The method of any of embodiments 1 to 7 wherein the information comprised in the first message comprises information that indicates a normalization function associated to at least one input data the ML or AI algorithm, or the ML or AI model thereof, and/or at least one output data the ML or AI algorithm, or the ML or AI model thereof.

Embodiment 9: The method of any of embodiments 1 to 8 wherein the information comprised in the first message comprises: (a) an indication of at least a maximum value or an upper bound value associated to at least one input data used for the ML or AI algorithm, or the ML or AI model thereof; (b) an indication of at least a minimum value or a lower bound value associated to at least one input data used for the ML or AI algorithm, or the ML or AI model thereof; (c) an indication of at least one statistical momentum associated to at least one input data used for the ML or AI algorithm, or the ML or AI model thereof; (d) an indication of at least a maximum value or an upper bound value associated to at least one output element of the ML or AI algorithm, or the ML or AI model thereof; (e) an indication of at least a minimum value or a lower bound value associated to at least one output element of the ML or AI algorithm, or the ML or AI model thereof; (f) an indication of at least one statistical momentum associated to at least one output element of the ML or AI algorithm, or the ML or AI model thereof; (g) an indication of at least one bias and/or scaling parameter to transform a distribution of at least one input or output element of the ML or AI algorithm, or the ML or AI model thereof; or (h) a combination of any two or more of (a)-(g).

Embodiment 10: The method of any of embodiments 1 to 9 wherein the information comprised in the first message comprises information that indicates: (a) an extended validity period associated to information about how to format data for execution of at least a ML or AI algorithm, or ML or AI model thereof, available at the first network node (600); (b) a level of accuracy associated to information about how to format data for execution of at least a ML or AI algorithm, or ML or AI model thereof, available at the first network node 600; (c) an indication of an expected performance degradation associated to information about how to format data for execution of at least a ML or AI algorithm, or ML or AI model thereof, available at the first network node 600; or (d) a combination of any two or more of (a)-(c).

Embodiment 11: The method of any of embodiments 1 to 10 wherein the first message further comprises information that identifies or defines the ML or AI algorithm, or the ML or AI model thereof.

Embodiment 12: The method of any of embodiments 1 to 11 further comprising, prior to receiving (604) the first message, transmitting (800) a second message to the second network node (602), the second message comprising a request for information about how to format data for execution of the at least the ML or AI algorithm, or the ML or AI model thereof.

Embodiment 13: The method of embodiment 12 wherein the second message comprises: (a) a request for at least a data scaling and/or descaling criterion (or function or operation) to be applied for at least one input data of the ML or AI algorithm, or the ML or AI model thereof; (b) a request for at least a data format to be applied for at least one input data of the ML or AI algorithm, or the ML or AI model thereof; (c) a request for at least a data scaling and/or de-scaling criterion (or function or operation) to be applied for at least one output data of the ML or AI algorithm, or the ML or AI model thereof; (d) a request for at least a data format to be used for at least one output data of the ML or AI algorithm, or the ML or AI model thereof; (e) a request for at least a normalization criterion (or a function or operation) to be applied for at least one input data of the ML or AI algorithm, or the ML or AI model thereof; (f) a request for at least a normalization criterion (or a function or operation) to be applied for at least one output data of the ML or AI algorithm, or the ML or AI model thereof; (g) a request for at least one parameter to be utilized in the normalization (function) to be applied for at least one input data and/or to an output data of the ML or AI algorithm, or the ML or AI model thereof; or (h) a combination of any two or more of (a)-(h).

Embodiment 14: The method of embodiment 12 or 13 wherein the second message comprises: (a) a request for at least a maximum value or an upper bound value associated to at least one input data used for the ML or AI algorithm, or the ML or AI model thereof; (b) a request for at least a minimum value or a lower bound value associated to at least one input data used for the ML or AI algorithm, or the ML or AI model thereof; (c) a request for at least one statistical momentum associated to at least one input data used for the ML or AI algorithm, or the ML or AI model thereof; (d) a request for at least a maximum value or an upper bound value associated to at least one output element of the ML or AI algorithm, or the ML or AI model thereof; (e) a request for at least a minimum value or a lower bound value associated to at least one output element of the ML or AI algorithm, or the ML or AI model thereof; (f) a request for at least one statistical momentum associated to at least one output element of the ML or AI algorithm, or the ML or AI model thereof; (g) a request for at least one bias and/or scaling parameter to transform a distribution of at least one input or output element of the ML or AI algorithm, or the ML or AI model thereof; or (h) a combination of any two or more of (a)-(g).

Embodiment 15: The method of any of embodiments 12 to 14 wherein the second message comprises: (a) a list of instructions to start, stop, pause, resume, or modify the reporting of assistance information associated to formatting data for at least the ML or AI algorithm, or the ML or AI model thereof, available at the first network node (600); (b) a list of at least one ML/AI algorithm, and/or ML/AI models thereof, for which reporting of data formatting from the second network node is requested; (c) a reporting periodicity; (d) a request for one-time reporting; (e) a reporting criteria; or (f) a combination of any two or more of (a)-(e).

Embodiment 16: The method of any of embodiments 12 to 15 further comprising receiving (900) a third message from the second network node (602), responsive to the second message, wherein the third message comprises an ACK or a NACK.

Embodiment 17: The method of any of embodiments 1 to 16 further comprising receiving (1000) a fourth message from the second network node (602), the fourth message comprising a request or configuration for the first network node (600) to provide at least one data sample generated by the first network node (600) upon executing (606) the ML or AL algorithm, or the ML or AL model thereof.

Embodiment 18: The method of any of embodiments 1 to 17 further comprising transmitting (1002) a fifth message to the second network node (602), the fifth message comprising at least one data sample generated by the first network node (600) upon executing (606) the ML or AL algorithm, or the ML or AL model thereof.

Embodiment 19: The method of embodiment 17 or 18 wherein the at least one data sample comprises: (a) a data sample associated to the execution of the ML or AL algorithm, or the ML or AL model thereof, prior to using the information about how the data is to be formatted comprised in the first message, (b) a data sample associated to the execution of the ML or AL algorithm, or the ML or AL model thereof, when using the information about how the data is to be formatted comprised in the first message, or (c) both (a) and (b).

Embodiment 20: The method of any of embodiments 17 to 19 wherein the at least one data sample comprises: (a) at least one input data to the ML or AL algorithm, or the ML or AL model thereof, (b) at least one output data provided by the ML or AL algorithm, or the ML or AL model thereof, or (c) both (a) and (b).

Embodiment 21: The method of any of embodiments 1 to 20 wherein the first network node (600) is a radio access network, RAN, node or a logical node within a RAN node.

Embodiment 22: The method of any of embodiments 1 to 20 wherein the first network node (600) is an orchestration and management, OAM, node, a service management and orchestration, SMO, node, or a node that is external to a radio access network, RAN.

Embodiment 23: The method of any of embodiments 1 to 20 wherein the first network node (600) is a network node responsible for one or more functions in an Open Radio Access Network, ORAN.

Embodiment 24: The method of any of embodiments 1 to 23 wherein the second network node (602) is an OAM node, a SMO node, or a node that is external to a radio access network, RAN.

Embodiment 25: A first network node (600; 1100) adapted to perform the method of any of embodiments 1 to 24.

Embodiment 26: A method performed by a second network node (602), the method comprising: transmitting (604) a first message to a first network node (600), the first message comprising information about how to format data for execution of at least a ML or AI algorithm, or ML or AI model thereof, that is available for execution at the first network node (600).

Embodiment 27: The method of embodiment 26 wherein the ML or AL algorithm, or the ML or AI model thereof, is trained at the second network node (602) and provided to the first network node (600) for execution.

Embodiment 28: The method of embodiment 26 or 27 wherein the ML or AI algorithm, or the ML or AI model thereof, is trained to optimize one or more operations or functions of the first network node (600) or to optimize one or more operations or configurations associated to a communication device connected to the first network node (600).

Embodiment 29: The method of any of embodiments 26 to 28 wherein the information comprised in the first message comprises: (a) an indication of at least a data scaling and/or descaling criterion (or function or operation) to be applied for at least one input data of the ML or AI algorithm, or the ML or AI model thereof; (b) an indication of at least a data format to be applied for at least one input data of the ML or AI algorithm, or the ML or AI model thereof; (c) an indication of at least a data scaling and/or de-scaling criterion (or function or operation) to be applied for at least one output data of the ML or AI algorithm, or the ML or AI model thereof; (d) an indication of at least a data format to be used for at least one output data of the ML or AI algorithm, or the ML or AI model thereof; (e) an indication of at least a normalization criterion (or a function or operation) to be applied for at least one input data of the ML or AI algorithm, or the ML or AI model thereof; (f) an indication of at least a normalization criterion (or a function or operation) to be applied for at least one output data of the ML or AI algorithm, or the ML or AI model thereof; (g) an indication of at least one parameter to be utilized in a normalization (function) to be applied for at least one input data and/or to an output data of the ML or AI algorithm, or the ML or AI model thereof; or (h) a combination of any two or more of (a)-(g).

Embodiment 30: The method of any of embodiments 26 to 29 wherein the information comprised in the first message comprises information that indicates a linear scaling function to be utilized by the first network node (600) to scale at least one input data the ML or AI algorithm, or the ML or AI model thereof, and/or to descale at least one output data the ML or AI algorithm, or the ML or AI model thereof.

Embodiment 31: The method of any of embodiments 26 to 30 wherein the information comprised in the first message comprises information that indicates a normalization function associated to at least one input data the ML or AI algorithm, or the ML or AI model thereof, and/or at least one output data the ML or AI algorithm, or the ML or AI model thereof.

Embodiment 32: The method of any of embodiments 26 to 31 wherein the information comprised in the first message comprises: (a) an indication of at least a maximum value or an upper bound value associated to at least one input data used for the ML or AI algorithm, or the ML or AI model thereof; (b) an indication of at least a minimum value or a lower bound value associated to at least one input data used for the ML or AI algorithm, or the ML or AI model thereof; (c) an indication of at least one statistical momentum associated to at least one input data used for the ML or AI algorithm, or the ML or AI model thereof; (d) an indication of at least a maximum value or an upper bound value associated to at least one output element of the ML or AI algorithm, or the ML or AI model thereof; (e) an indication of at least a minimum value or a lower bound value associated to at least one output element of the ML or AI algorithm, or the ML or AI model thereof; (f) an indication of at least one statistical momentum associated to at least one output element of the ML or AI algorithm, or the ML or AI model thereof; (g) an indication of at least one bias and/or scaling parameter to transform a distribution of at least one input or output element of the ML or AI algorithm, or the ML or AI model thereof; or (h) a combination of any two or more of (a)-(g).

Embodiment 33: The method of any of embodiments 26 to 32 wherein the information comprised in the first message comprises information that indicates: (a) an extended validity period associated to information about how to format data for execution of at least a ML or AI algorithm, or ML or AI model thereof, available at the first network node (600); (b) a level of accuracy associated to information about how to format data for execution of at least a ML or AI algorithm, or ML or AI model thereof, available at the first network node 600; (c) an indication of an expected performance degradation associated to information about how to format data for execution of at least a ML or AI algorithm, or ML or AI model thereof, available at the first network node 600; or (d) a combination of any two or more of (a)-(c).

Embodiment 34: The method of any of embodiments 26 to 33 wherein the first message further comprises information that defines the ML or AI algorithm, or the ML or AI model thereof.

Embodiment 35: The method of any of embodiments 26 to 34 further comprising, prior to transmitting (604) the first message, receiving (800) a second message from the first network node (600), the second message comprising a request for information about how to format data for execution of the at least the ML or AI algorithm, or the ML or AI model thereof.

Embodiment 36: The method of embodiment 35 wherein the second message comprises: (a) a request for at least a data scaling and/or descaling criterion (or function or operation) to be applied for at least one input data of the ML or AI algorithm, or the ML or AI model thereof; (b) a request for at least a data format to be applied for at least one input data of the ML or AI algorithm, or the ML or AI model thereof; (c) a request for at least a data scaling and/or de-scaling criterion (or function or operation) to be applied for at least one output data of the ML or AI algorithm, or the ML or AI model thereof; (d) a request for at least a data format to be used for at least one output data of the ML or AI algorithm, or the ML or AI model thereof; (e) a request for at least a normalization criterion (or a function or operation) to be applied for at least one input data of the ML or AI algorithm, or the ML or AI model thereof; (f) a request for at least a normalization criterion (or a function or operation) to be applied for at least one output data of the ML or AI algorithm, or the ML or AI model thereof; (g) a request for at least one parameter to be utilized in the normalization (function) to be applied for at least one input data and/or to an output data of the ML or AI algorithm, or the ML or AI model thereof; or (h) a combination of any two or more of (a)-(g).

Embodiment 37: The method of embodiment 35 or 36 wherein the second message comprises: (a) a request for at least a maximum value or an upper bound value associated to at least one input data used for the ML or AI algorithm, or the ML or AI model thereof; (b) a request for at least a minimum value or a lower bound value associated to at least one input data used for the ML or AI algorithm, or the ML or AI model thereof; (c) a request for at least one statistical momentum associated to at least one input data used for the ML or AI algorithm, or the ML or AI model thereof; (d) a request for at least a maximum value or an upper bound value associated to at least one output element of the ML or AI algorithm, or the ML or AI model thereof; (e) a request for at least a minimum value or a lower bound value associated to at least one output element of the ML or AI algorithm, or the ML or AI model thereof; (f) a request for at least one statistical momentum associated to at least one output element of the ML or AI algorithm, or the ML or AI model thereof; (g) a request for at least one bias and/or scaling parameter to transform a distribution of at least one input or output element of the ML or AI algorithm, or the ML or AI model thereof; or (h) a combination of any two or more of (a)-(g).

Embodiment 38: The method of any of embodiments 35 to 37 wherein the second message comprises: (a) a list of instructions to start, stop, pause, resume, or modify the reporting of assistance information associated to formatting data for at least the ML or AI algorithm, or the ML or AI model thereof, available at the first network node (600); (b) a list of at least one ML/AI algorithm, and/or ML/AI models thereof, for which reporting of data formatting from the second network node is requested; (c) a reporting periodicity; (d) a request for one-time reporting; (e) a reporting criteria; or (f) a combination of any two or more of (a)-(e).

Embodiment 39: The method of any of embodiments 35 to 38 further comprising transmitting (900) a third message to the first network node (600), responsive to the second message, wherein the third message comprises an ACK or a NACK.

Embodiment 40: The method of any of embodiments 26 to 39 further comprising transmitting (1000) a fourth message to the first network node (600), the fourth message comprising a request or configuration for the first network node (600) to provide at least one data sample generated by the first network node (600) upon executing (606) the ML or AL algorithm, or the ML or AL model thereof.

Embodiment 41: The method of any of embodiments 26 to 40 further comprising receiving (1002) a fifth message from the first network node (600), the fifth message comprising at least one data sample generated by the first network node (600) upon executing (606) the ML or AL algorithm, or the ML or AL model thereof.

Embodiment 42: The method of embodiment 40 or 41 wherein the at least one data sample comprises: (a) a data sample associated to the execution of the ML or AL algorithm, or the ML or AL model thereof, prior to using the information about how the data is to be formatted comprised in the first message, (b) a data sample associated to the execution of the ML or AL algorithm, or the ML or AL model thereof, when using the information about how the data is to be formatted comprised in the first message, or (c) both (a) and (b).

Embodiment 43: The method of any of embodiments 40 to 42 wherein the at least one data sample comprises: (a) at least one input data to the ML or AL algorithm, or the ML or AL model thereof, (b) at least one output data provided by the ML or AL algorithm, or the ML or AL model thereof, or (c) both (a) and (b).

Embodiment 44: The method of any of embodiments 26 to 43 wherein the first network node (600) is a radio access network, RAN, node or a logical node within a RAN node.

Embodiment 45: The method of any of embodiments 26 to 43 wherein the first network node (600) is an orchestration and management, OAM, node, a service management and orchestration, SMO, node, or a node that is external to a radio access network, RAN.

Embodiment 46: The method of any of embodiments 26 to 43 wherein the first network node (600) is a network node responsible for one or more functions in an Open Radio Access Network, ORAN.

Embodiment 47: The method of any of embodiments 26 to 46 wherein the second network node (602) is an OAM node, a SMO node, or a node that is external to a radio access network, RAN.

Embodiment 48: A second network node (604) adapted to perform the method of any of embodiments 26 to 47.

Those skilled in the art will recognize improvements and modifications to the embodiments of the present disclosure. All such improvements and modifications are considered within the scope of the concepts disclosed herein.

1. A method performed by a first network node, the method comprising:
receiving a first message from a second network node, the first message comprising information about how to format data for execution of at least a machine learning, ML, or artificial intelligence, AI, process, or ML or AI model thereof, that is available for execution at the first network node; and
executing the at least a ML or AI process, or the ML or AI model thereof, based on the information comprised in the first message.

2. The method of claim 1 wherein the ML or AI process, or the ML or AI model thereof, is trained at the second network node and provided to the first network node.

3. The method of claim 1 wherein executing the at least a ML or AI process, or the ML or AI model thereof, based on the information comprised in the first message comprises formatting at least one input data provided to the ML or AL process, or the ML or AI model thereof, and/or at least one output data provided by the ML or AL process, or the ML or AI model thereof, based on the information comprised in the first message.

4. The method of claim 1 wherein executing the at least a ML or AI process, or the ML or AI model thereof, based on the information comprised in the first message comprises:
(a) formatting information used as input to the ML or AI process, or the ML or AI model thereof, based on scaling information comprised in the information comprised the first message;
(b) obtaining an output from the ML or AI process, or the ML or AI model thereof, by executing the ML or AI process, or the ML or AI model thereof, using input data formatted according to the information comprised in the first message;
(c) formatting an output provided by the ML or AI process, or the ML or AI model thereof, based on de-scaling information comprised in the formatting information comprised in the first message;
(d) applying an output provided by the ML or AI process, or the ML or AI model thereof, that is formatted according to the information comprised in the first message to an associated network function or communication device; or
(e) a combination of any two or more of (a)-(d).

5. The method of claim 1 wherein the ML or AI process, or the ML or AI model thereof, is trained to optimize one or more operations or functions of the first network node or to optimize one or more operations or configurations associated to a communication device connected to the first network node.

6. The method of claim 1 wherein the information comprised in the first message comprises:
(a) an indication of at least a data scaling and/or descaling criterion to be applied for at least one input data of the ML or AI process, or the ML or AI model thereof;
(b) an indication of at least a data format to be applied for at least one input data of the ML or AI process, or the ML or AI model thereof;
(c) an indication of at least a data scaling and/or de-scaling criterion to be applied for at least one output data of the ML or AI process, or the ML or AI model thereof;
(d) an indication of at least a data format to be used for at least one output data of the ML or AI process, or the ML or AI model thereof;
(e) an indication of at least a normalization criterion to be applied for at least one input data of the ML or AI process, or the ML or AI model thereof;
(f) an indication of at least a normalization criterion to be applied for at least one output data of the ML or AI process, or the ML or AI model thereof;
(g) an indication of at least one parameter to be utilized in a normalization function to be applied for at least one input data and/or to an output data of the ML or AI process, or the ML or AI model thereof; or
(h) a combination of any two or more of (a)-(g).

7. The method of claim 1 wherein the information comprised in the first message comprises information that indicates a linear or non-linear scaling function to be utilized by the first network node to scale at least one input data to the ML or AI process, or the ML or AI model thereof, and/or to descale at least one output data of the ML or AI process, or the ML or AI model thereof.

8. The method of claim 1 wherein the information comprised in the first message comprises:
(a) an indication of at least a maximum value or an upper bound value associated to at least one input data used for the ML or AI process, or the ML or AI model thereof;
(b) an indication of at least a minimum value or a lower bound value associated to at least one input data used for the ML or AI process, or the ML or AI model thereof;
(c) an indication of at least one statistical momentum associated to at least one input data used for the ML or AI process, or the ML or AI model thereof;
(d) an indication of at least a maximum value or an upper bound value associated to at least one output element of the ML or AI process, or the ML or AI model thereof;
(e) an indication of at least a minimum value or a lower bound value associated to at least one output element of the ML or AI process, or the ML or AI model thereof;
(f) an indication of at least one statistical momentum associated to at least one output element of the ML or AI process, or the ML or AI model thereof;
(g) an indication of at least one bias and/or scaling parameter to transform a distribution of at least one input or output element of the ML or AI process, or the ML or AI model thereof; or
(h) a combination of any two or more of (a)-(g).

9. The method of claim 1 wherein the information comprised in the first message comprises information that indicates:
(a) an extended validity period associated to information about how to format data for execution of at least a ML or AI process, or ML or AI model thereof, available at the first network node;
(b) a level of accuracy associated to information about how to format data for execution of at least a ML or AI process, or ML or AI model thereof, available at the first network node;
(c) an indication of an expected performance degradation associated to information about how to format data for execution of at least a ML or AI process, or ML or AI model thereof, available at the first network node; or
(d) a combination of any two or more of (a)-(c).

10. The method of claim 1 further comprising,
prior to receiving the first message, transmitting a second message to the second network node, the second message comprising a request for information about how to format data for execution of the at least the ML or AI process, or the ML or AI model thereof.

11. The method of claim 10 wherein the second message comprises:
(a) a request for at least a data scaling and/or descaling criterion to be applied for at least one input data of the ML or AI process, or the ML or AI model thereof;
(b) a request for at least a data format to be applied for at least one input data of the ML or AI process, or the ML or AI model thereof;
(c) a request for at least a data scaling and/or de-scaling criterion to be applied for at least one output data of the ML or AI process, or the ML or AI model thereof;
(d) a request for at least a data format to be used for at least one output data of the ML or AI process, or the ML or AI model thereof;
(e) a request for at least a normalization criterion to be applied for at least one input data of the ML or AI process, or the ML or AI model thereof;
(f) a request for at least a normalization criterion to be applied for at least one output data of the ML or AI process, or the ML or AI model thereof;
(g) a request for at least one parameter to be utilized in the normalization function to be applied for at least one input data and/or to an output data of the ML or AI process, or the ML or AI model thereof; or
(h) a combination of any two or more of (a)-(h).

12. The method of claim 10 wherein the second message comprises:
(a) a request for at least a maximum value or an upper bound value associated to at least one input data used for the ML or AI process, or the ML or AI model thereof;
(b) a request for at least a minimum value or a lower bound value associated to at least one input data used for the ML or AI process, or the ML or AI model thereof;
(c) a request for at least one statistical momentum associated to at least one input data used for the ML or AI process, or the ML or AI model thereof;
(d) a request for at least a maximum value or an upper bound value associated to at least one output element of the ML or AI process, or the ML or AI model thereof;
(e) a request for at least a minimum value or a lower bound value associated to at least one output element of the ML or AI process, or the ML or AI model thereof;
(f) a request for at least one statistical momentum associated to at least one output element of the ML or AI process, or the ML or AI model thereof;
(g) a request for at least one bias and/or scaling parameter to transform a distribution of at least one input or output element of the ML or AI process, or the ML or AI model thereof; or
(h) a combination of any two or more of (a)-(g).

13. The method of claim 10 wherein the second message comprises:
(a) a list of instructions to start, stop, pause, resume, or modify the reporting of assistance information associated to formatting data for at least the ML or AI process, or the ML or AI model thereof, available at the first network node;
(b) a list of at least one ML/AI process, and/or ML/AI models thereof, for which reporting of data formatting from the second network node is requested;
(c) a reporting periodicity;
(d) a request for one-time reporting;
(e) a reporting criteria; or
(f) a combination of any two or more of (a)-(e).

14. The method of claim 1 further comprising receiving a fourth message from the second network node, the fourth message comprising a request or configuration for the first network node to provide at least one data sample generated by the first network node upon executing the ML or AL process, or the ML or AL model thereof.

15. The method of claim 1 further comprising transmitting a fifth message to the second network node, the fifth message comprising at least one data sample generated by the first network node upon executing the ML or AL process, or the ML or AL model thereof.

16. The method of claim 14 wherein the at least one data sample comprises: (a) a data sample associated to the execution of the ML or AL process, or the ML or AL model thereof, prior to using the information about how the data is to be formatted comprised in the first message, (b) a data sample associated to the execution of the ML or AL process, or the ML or AL model thereof, when using the information about how the data is to be formatted comprised in the first message, or (c) both (a) and (b).

17. The method of claim 14 wherein the at least one data sample comprises: (a) at least one input data to the ML or AL process, or the ML or AL model thereof, (b) at least one output data provided by the ML or AL process, or the ML or AL model thereof, or (c) both (a) and (b).

18. A first network node comprising processing circuitry configured to cause the first network node to:
receive a first message from a second network node, the first message comprising information about how to format data for execution of at least a machine learning, ML, or artificial intelligence, AI, process, or ML or AI model thereof, that is available for execution at the first network node; and
execute the at least a ML or AI process, or the ML or AI model thereof, based on the information comprised in the first message.

19. (canceled)

20. A method performed by a second network node, the method comprising:
transmitting a first message to a first network node, the first message comprising information about how to format data for execution of at least a machine learning, ML, or artificial intelligence, AI, process, or ML or AI model thereof, that is available for execution at the first network node.

21. A second network node comprising processing circuitry configured to cause the second network node to:
transmit a first message to a first network node, the first message comprising information about how to format data for execution of at least a machine learning, ML, or artificial intelligence, AI, process, or ML or AI model thereof, that is available for execution at the first network node.
